(19) United States
(12) Patent Application Publication
(10) Pub. No.: US 2026/0252391 A1
(43) Pub. Date: Aug. 27, 2026

(54) Microservices Based Simultaneous Execution via Multiple Cloud Service Providers

(71) Applicant: Bank of America Corporation, Charlotte, NC (US)

(72) Inventors: Maharaj Mukherjee, Poughkeepsie, NY (US); Carl Benda, Charlotte, NC (US)

(21) Appl. No.: 19/059,424

(22) Filed: Feb. 21, 2025

(51) Int. Cl. G06F 9/50

(52) U.S. Cl. CPC G06F 9/5027

(57) ABSTRACT

A system and method for dynamically selecting, executing, and optimizing microservices across multiple cloud service providers is disclosed. A workload management system receives a microservice execution request, retrieves metadata from a microservices catalog, and selects an optimal cloud provider using a weighted cost function based on execution performance, cost, security compliance, and availability. A machine learning model refines provider selection using historical execution data. An API abstraction layer formats and encrypts execution requests before transmission. A performance monitoring module tracks execution, while a fault detection module identifies failures and triggers automated failover via a failover module that preemptively replicates execution state data. A response processing module validates execution results before returning them to the requesting application. The system ensures dynamic, cost-efficient, and secure workload distribution while maintaining seamless failover resilience. By leveraging real-time performance metrics, historical data, and predictive analytics, the system optimizes microservice execution across diverse cloud environments.

### TECHNICAL FIELD

The inventions disclosed herein pertain to the fields of cloud computing and distributed processing, artificial intelligence and machine learning, computer networking and communication protocols, software architecture and microservices, and parallel and high-performance computing. In the field of cloud computing and distributed processing, the inventions optimize workload execution by dynamically selecting and allocating computing resources across multiple cloud service providers. In the field of artificial intelligence and machine learning, the inventions employ predictive algorithms and heuristic models to analyze historical performance data and autonomously select the most efficient cloud service provider based on predefined optimization criteria. In the field of computer networking and communication protocols, the inventions facilitate efficient data transfers and secure communication between distributed cloud environments by dynamically routing service requests to optimize network performance. In the field of software architecture and microservices, the inventions introduce a cloud-agnostic framework that abstracts vendor-specific protocols, allowing for seamless execution of computational tasks across different cloud platforms through standardized application programming interfaces. In the field of parallel and high-performance computing, the inventions enhance workload management in virtualized environments by leveraging real-time monitoring, load balancing, and intelligent task migration to maximize efficiency and minimize execution costs. Collectively, these innovations provide a comprehensive solution for optimizing cloud-based computing through intelligent workload distribution, adaptive resource allocation, and enhanced interoperability across diverse cloud service providers.

### DESCRIPTION OF THE RELATED ART

In modern cloud computing environments, organizations increasingly rely on multiple cloud service providers to host and execute critical computing workloads. Each cloud provider, such as AWS, Microsoft Azure, Google Cloud Platform, and others, offers a diverse set of services that perform similar functionalities but differ in execution efficiency, cost structures, and underlying architectures. Despite these similarities, enterprises face significant challenges in seamlessly utilizing cloud services across multiple vendors. Each provider enforces its own set of proprietary protocols, authentication mechanisms, and API structures, creating operational silos that hinder interoperability. As a result, businesses struggle to optimize performance and cost across cloud environments because transitioning workloads between providers requires extensive manual intervention, reconfiguration, and software redevelopment.

One fundamental issue in multi-cloud computing is the lack of an intelligent mechanism for dynamically selecting the most efficient and cost-effective cloud service at any given moment. Each provider's computing environment fluctuates in terms of workload availability, resource pricing, and computational performance. Due to variations in demand and infrastructure limitations, a service that is optimal at one point in time may become suboptimal moments later. Without an automated way to monitor and respond to these fluctuations, enterprises must either commit to a single cloud provider, thereby forgoing potential cost and efficiency advantages, or manually reassign workloads across providers in a time-consuming and error-prone process.

Another major challenge is the difficulty in maintaining compatibility across different cloud ecosystems. Cloud providers implement unique API designs and security frameworks, making it arduous to integrate services from multiple vendors into a cohesive workflow. Developers often need to write custom software to interact with each provider's API, which introduces complexity and increases maintenance costs. The lack of standardization means that organizations must dedicate significant engineering resources to adapting their applications to different cloud environments, further exacerbating the inefficiencies of a multi-cloud strategy.

Scalability concerns further compound these challenges. In many cases, organizations need to scale their computing workloads dynamically based on real-time demand. However, the process of scaling workloads across multiple cloud vendors is non-trivial, as each provider has different limitations on resource provisioning, instance spin-up times, and load-balancing mechanisms. Companies often experience bottlenecks when their primary cloud provider reaches capacity limits or suffers from degraded performance. Without a seamless way to shift workloads to an alternate cloud provider in real time, organizations face interruptions, increased latency, and potential service failures.

Security and compliance also present significant obstacles to multi-cloud adoption. Different cloud providers have varying regulatory compliance certifications and security standards. Enterprises operating in regulated industries must ensure that sensitive data remains protected and that workloads execute in environments that comply with industry-specific regulations. However, the process of assessing compliance across multiple providers, ensuring secure data transfer, and managing authentication across different security frameworks is cumbersome and resource intensive. This complexity often forces companies to remain locked into a single cloud provider, limiting their ability to take advantage of competitive pricing and service improvements from other vendors.

Performance variability is another critical problem faced by organizations using multiple cloud providers. Computing performance is influenced by various factors such as server availability, network latency, and hardware configurations. Different providers have different capabilities in areas such as GPU acceleration, storage access speeds, and network bandwidth. A task that executes efficiently on one cloud provider may perform poorly on another due to infrastructure differences. Without a mechanism to continuously evaluate and adapt to performance variations, organizations are unable to maximize execution efficiency and are often forced to overprovision cloud resources to account for worst-case scenarios, leading to unnecessary expenditures.

Cost inefficiencies further hinder organizations attempting to leverage multiple cloud providers. Cloud pricing models are highly dynamic, with rates fluctuating based on demand, region, and resource availability. Some providers offer lower rates for specific services, while others impose higher costs during peak usage periods. Without a real-time system for evaluating and selecting the most cost-effective provider for a given task, companies are unable to take full advantage of cost savings opportunities. Instead, they often rely on static provisioning strategies that lock them into less-than-optimal pricing structures, leading to significant unnecessary expenses over time.

Vendor lock-in is another pressing concern for enterprises. When an organization builds its cloud infrastructure around a single provider's proprietary tools and services, migrating to another provider becomes highly challenging. The lack of standardization across cloud platforms means that businesses must invest considerable time and resources into rewriting applications, adapting configurations, and retraining staff to accommodate a new provider's ecosystem. This dependency limits flexibility and prevents organizations from capitalizing on advancements in cloud technology offered by competing providers.

Another key issue is the fragmentation of cloud service capabilities. While cloud providers offer similar functionalities, such as machine learning, storage, and analytics, they vary in terms of performance, API design, and feature sets. An enterprise may find that one provider's AI model inference service is more cost-effective and powerful than another's, but the lack of seamless integration prevents organizations from dynamically switching between equivalent services. This limitation forces companies to make suboptimal decisions, either using inferior services for convenience or spending excessive resources on integration efforts.

The complexity of workload orchestration across multiple cloud providers also poses a significant barrier. Each cloud vendor has its own scheduling, resource allocation, and job execution mechanisms. Organizations need a way to coordinate workloads across these disparate environments while maintaining high availability, redundancy, and fault tolerance. Traditional cloud management tools lack the intelligence needed to distribute workloads dynamically based on real-time conditions, resulting in inefficiencies, downtime risks, and excessive operational overhead.

Latency and data locality issues further exacerbate multi-cloud inefficiencies. Different cloud providers maintain data centers in various geographic regions, and the physical distance between computing resources can significantly impact response times. In scenarios requiring low-latency processing, such as high-frequency trading or real-time analytics, organizations need to ensure that workloads are executed in the closest and fastest cloud environment. However, without an intelligent system to factor in data locality, businesses struggle to maintain optimal performance levels across distributed cloud infrastructures.

Interoperability between cloud-native applications is another hurdle in multi-cloud environments. Many cloud services are built to work seamlessly within a single provider's ecosystem but lack built-in support for cross-cloud interactions. This limitation forces organizations to develop custom middleware and integration solutions, increasing software complexity and reducing maintainability. Without a unified framework for enabling cross-cloud communication, companies must navigate significant technical challenges to achieve a truly vendor-agnostic cloud strategy.

Reliability concerns further hinder multi-cloud adoption. While cloud providers advertise high uptime guarantees, service outages are inevitable. Organizations need the ability to failover between cloud providers seamlessly when outages occur. However, most enterprises lack the infrastructure to automatically detect failures and shift workloads between providers without manual intervention. As a result, businesses experience costly downtime when their primary cloud provider suffers a disruption.

Operational overhead associated with managing multiple cloud providers is another barrier. IT teams must monitor, configure, and optimize cloud workloads across different vendor platforms, each with its own set of management tools, billing interfaces, and performance metrics. Without a unified management system, maintaining multi-cloud infrastructure requires significant effort, increasing complexity and reducing agility. This overhead discourages enterprises from fully leveraging a multi-cloud approach, despite its potential benefits.

The long-felt and unmet need for a solution to these challenges is evident in the increasing reliance on multi-cloud environments without an effective mechanism to optimize execution efficiency, cost, and interoperability. Enterprises have struggled for years to balance performance, pricing, and scalability across multiple cloud providers, often resorting to suboptimal workarounds or maintaining costly single-provider dependencies. Existing cloud management tools lack the intelligence to dynamically select, route, and execute workloads in a way that maximizes efficiency while minimizing cost. A comprehensive solution that seamlessly integrates multi-cloud environments, dynamically optimizes execution conditions, and eliminates the inefficiencies associated with manual workload allocation has been long overdue. Without such a solution, organizations remain constrained by technical limitations, high costs, and operational complexity, preventing them from fully realizing the benefits of a multi-cloud strategy.

### SUMMARY OF THE INVENTION

The inventions disclosed herein provide sophisticated systems and methods for dynamically managing the execution of microservices across multiple cloud service providers. They introduce an intelligent, cloud-agnostic approach that allows workloads to be executed in real-time based on a comprehensive evaluation of performance metrics, cost structures, and efficiency parameters. The system is designed to operate seamlessly across heterogeneous cloud environments, ensuring that applications can leverage the best possible computational resources at any given time. Unlike conventional cloud management solutions that require manual intervention or static configurations, the invention autonomously determines the optimal execution environment for each microservice and seamlessly directs workloads to the most suitable cloud provider.

A fundamental aspect of the invention is the structured catalog of microservices, which serves as a repository of available computational functions that can be executed across multiple cloud platforms. Each microservice is standardized in terms of input and output formats, ensuring that applications can call services without being constrained by provider-specific requirements. This design enables a truly cloud-agnostic approach where enterprises can transition workloads between providers without modifying the underlying application logic. By maintaining a catalog that defines each microservice in a uniform manner, the system ensures that execution remains consistent regardless of which cloud provider is ultimately selected.

The system incorporates an intelligent selector, a key innovation that enables real-time decision-making for workload distribution. This selector continuously analyzes cloud service performance data, cost parameters, and workload-specific requirements to determine where a given task should be executed. The decision-making process is guided by a dynamic cost function that considers multiple weighted factors, such as processing speed, resource availability, latency, and financial cost. This ensures that workloads are always routed to the cloud provider that offers the best combination of performance and cost efficiency. The intelligent selector operates autonomously, eliminating the need for manual oversight and allowing enterprises to benefit from fully automated cloud resource optimization.

A critical innovation of the invention is its ability to facilitate real-time transitions between cloud providers while maintaining uninterrupted service execution. Unlike conventional approaches that require downtime or extensive reconfiguration to shift workloads, the system continuously monitors cloud provider performance and dynamically reroutes computational tasks as needed. If a particular cloud provider experiences degradation in performance or an increase in pricing, the system proactively shifts workloads to an alternate provider that meets the required execution criteria. This dynamic switching capability ensures that enterprises can always operate at peak efficiency without suffering performance bottlenecks or incurring unnecessary costs.

The invention introduces a cloud vendor abstraction layer, which serves as an interface between applications and cloud providers. This abstraction layer standardizes interactions with cloud services, allowing applications to issue service requests without being tied to the proprietary protocols or APIs of any specific cloud provider. When an application makes a request for a microservice, the system translates the request into the appropriate format for the selected cloud provider, ensuring seamless interoperability. By abstracting cloud vendor-specific details, the invention significantly reduces the complexity of multi-cloud adoption and allows enterprises to integrate diverse cloud services without extensive development effort.

A powerful machine learning component is embedded within the invention to enhance decision-making processes. The system continuously collects historical performance data from cloud service executions and applies predictive analytics to refine workload distribution strategies. By analyzing past execution trends, the system can anticipate fluctuations in cloud provider performance and adjust workload assignments proactively. This adaptive learning mechanism allows the system to improve its efficiency over time, ensuring that computational tasks are always executed in the most optimal cloud environment. The incorporation of machine learning also enables the system to recognize patterns in cloud service pricing, allowing enterprises to capitalize on cost-saving opportunities dynamically.

The invention supports a broad range of computational tasks, including but not limited to data processing, real-time analytics, artificial intelligence model inference, sorting and filtering operations, and mathematical computations. Any stateless function that can be executed independently is a suitable candidate for optimization using this system. This flexibility makes the invention applicable across a variety of industries, including finance, telecommunications, e-commerce, and other sectors that require high-performance cloud computing. By enabling dynamic workload distribution across multiple cloud providers, the system provides organizations with a level of efficiency and scalability that is not achievable with traditional cloud management approaches.

A unique feature of the invention is its use of a performance evaluation matrix that ranks cloud providers based on real-time efficiency metrics. This matrix continuously updates based on observed execution times, error rates, processing speeds, and other performance indicators. The system references this matrix when selecting a cloud provider for a given microservice, ensuring that workload assignments are always based on the most current performance data available. Additionally, a cost analysis model is integrated into the selection process, factoring in variables such as CPU pricing, memory usage, bandwidth costs, and region-specific pricing structures. This ensures that workloads are routed not only for maximum performance but also for optimal cost savings.

The system incorporates built-in security and compliance mechanisms that allow enterprises to enforce specific regulatory requirements when selecting cloud providers. Many industries, such as finance, require strict adherence to data security regulations and jurisdictional restrictions on where data can be processed. The system takes these constraints into account when selecting a cloud provider, ensuring that workloads are executed in environments that comply with legal and regulatory standards. Enterprises can configure policies to define acceptable execution environments, and the intelligent selector will automatically exclude providers that do not meet these criteria.

Scalability is another core aspect of the invention. As new cloud service providers enter the market or existing providers evolve their offerings, the system can seamlessly incorporate additional microservices and expand its selection capabilities. This extensibility ensures that enterprises can continuously take advantage of new cloud computing advancements without being locked into a static infrastructure. Whether an organization operates with two cloud providers or a dozen, the system dynamically scales to accommodate varying workloads and execution requirements.

Reliability and fault tolerance are built into the invention through automated failover mechanisms. If a cloud provider experiences downtime, degraded performance, or service interruptions, the system immediately redirects workloads to an alternate provider with minimal disruption. This failover capability ensures business continuity and prevents service outages from affecting critical operations. Unlike traditional cloud architectures where failover must be manually configured, the invention automates the process, making real-time workload transitions seamless and instantaneous.

Another advantage of the invention is its ability to handle fluctuating workload demands efficiently. Organizations often experience variable computational needs depending on business cycles, seasonal trends, or real-time events. The system is designed to allocate workloads dynamically, scaling resources up or down as needed. During peak demand periods, it distributes workloads across multiple providers to prevent resource bottlenecks. Conversely, during off-peak times, it consolidates workloads onto the most cost-effective provider, thereby reducing unnecessary cloud expenditure.

The invention also provides enterprises with in-depth monitoring and analytics tools that offer real-time visibility into cloud resource usage, execution performance, and cost savings. A user interface allows administrators to access detailed reports on cloud provider efficiency, historical workload trends, and cost breakdowns. This level of transparency enables enterprises to fine-tune their cloud strategies, adjust execution parameters, and maximize return on investment. The analytics dashboard further supports predictive insights that help organizations anticipate performance variations and proactively adjust execution strategies.

A key differentiator of the invention is its ability to function as a middleware solution that seamlessly integrates with existing enterprise infrastructure. Unlike conventional cloud management solutions that require extensive reconfiguration, the system operates as an intermediary layer between applications and cloud services. This means that enterprises can adopt a multi-cloud strategy without making significant changes to their existing software architecture. The system provides a streamlined interface that allows applications to interact with cloud services in a vendor-agnostic manner, simplifying deployment and management.

Overall, the invention delivers a transformative approach to multi-cloud computing by providing an intelligent, automated, and highly scalable framework for workload execution. By leveraging microservices, machine learning-driven decision-making, real-time optimization, and seamless interoperability, the system empowers enterprises to maximize performance, minimize costs, and enhance computational efficiency. The invention overcomes the traditional barriers to multi-cloud adoption and introduces a sophisticated yet accessible solution for organizations looking to harness the full potential of cloud computing. Through its advanced capabilities, the system revolutionizes how enterprises manage and execute workloads in an increasingly complex and dynamic cloud landscape.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a computer-implemented method for dynamically selecting and executing microservices across multiple cloud service providers includes receiving, by a workload management system, a request for execution of a microservice, where the request includes input data and execution constraints. The method includes retrieving, by a microservices catalog stored in a memory of the workload management system, metadata associated with the microservice, where the metadata comprises a list of cloud service providers capable of executing the microservice, expected input and output formats, and compliance requirements. The method includes identifying, by a cloud provider selection engine of the workload management system, a set of available cloud service providers from the list of cloud service providers in the microservices catalog that meet predefined execution constraints, wherein the predefined execution constraints include execution cost, computational performance, security compliance, and geographical availability. The method includes retrieving, by a historical performance database of the workload management system, execution performance data for each cloud service provider in the set of available cloud service providers, where the execution performance data comprises prior execution times, error rates, response latencies, and cost metrics.

The method includes evaluating, by an intelligent selection module of the workload management system, each cloud service provider in the set of available cloud service providers by applying a weighted cost function, where the weighted cost function is computed based on the execution performance data, execution cost, service availability, and predefined user constraints. The method includes selecting, by the intelligent selection module, an optimal cloud service provider for executing the microservice, where the optimal cloud service provider is determined based on a lowest computed value of the weighted cost function.

The method includes retrieving, by an application programming interface (API) abstraction layer of the workload management system, a cloud-specific API endpoint corresponding to the optimal cloud service provider, where the cloud-specific API endpoint is stored in a cloud provider registry of the workload management system. The method includes formatting, by the API abstraction layer, the request for execution of the microservice into a provider-specific API request, where the provider-specific API request conforms to an API specification of the optimal cloud service provider.

The method includes transmitting, by the workload management system, the provider-specific API request to the optimal cloud service provider for execution. The method includes monitoring, by a performance monitoring module of the workload management system, an execution status of the microservice on the optimal cloud service provider, where monitoring comprises collecting execution time, response quality, and resource utilization data. The method includes storing, by the historical performance database, the execution time, response quality, and resource utilization data associated with the execution of the microservice for future workload optimization.

The method includes analyzing, by a machine learning model stored in a memory of the workload management system, the execution time, response quality, and resource utilization data to identify patterns in cloud service performance trends. The method includes updating, by the workload management system, the weighted cost function based on predicted execution performance determined by the machine learning model.

The method includes determining, by a fault detection module of the workload management system, whether the optimal cloud service provider has failed or is experiencing performance degradation based on a threshold deviation from historical execution performance. The method includes, upon determining that the optimal cloud service provider has failed or is experiencing performance degradation, dynamically rerouting, by a failover module of the workload management system, execution of the microservice to an alternate cloud service provider selected based on an updated evaluation of the weighted cost function.

The method includes receiving, by the workload management system, a response from the optimal cloud service provider or the alternate cloud service provider, where the response comprises an output result generated by execution of the microservice. The method includes transmitting, by the workload management system, the output result to a requesting application.

In some arrangements, the computer-implemented method includes retrieving, by the historical performance database, execution performance data for each cloud service provider in the set of available cloud service providers, where retrieving the execution performance data further comprises retrieving real-time cloud provider resource availability, including current CPU utilization, memory availability, network bandwidth, and active workload queues.

In some arrangements, the computer-implemented method includes evaluating, by the intelligent selection module, each cloud service provider in the set of available cloud service providers, where evaluating further comprises dynamically adjusting weight values in the weighted cost function based on historical workload trends, execution priority, and predefined service level agreement constraints.

In some arrangements, the computer-implemented method includes selecting, by the intelligent selection module, the optimal cloud service provider for executing the microservice, where selecting further comprises excluding cloud service providers that have been flagged for security vulnerabilities or compliance violations within a predefined monitoring period.

In some arrangements, the computer-implemented method includes formatting, by the API abstraction layer, the request for execution of the microservice into a provider-specific API request, where formatting further comprises applying protocol translation to adapt the request to one or more of REST, gRPC, WebSockets, GraphQL, or a provider-specific API format.

In some arrangements, the computer-implemented method includes transmitting, by the workload management system, the provider-specific API request to the optimal cloud service provider for execution, where transmitting further comprises encrypting the provider-specific API request using a secure encryption algorithm prior to transmission and decrypting the response upon receipt.

In some arrangements, the computer-implemented method includes monitoring, by the performance monitoring module, the execution status of the microservice, where monitoring further comprises detecting execution anomalies by analyzing response latencies, error codes, and resource consumption spikes using anomaly detection models.

In some arrangements, the computer-implemented method includes analyzing, by the machine learning model, the execution time, response quality, and resource utilization data, where analyzing further comprises training the machine learning model using a federated learning approach that updates the model using execution data from multiple distributed cloud environments without centralizing sensitive execution data.

In some arrangements, the computer-implemented method includes determining, by the fault detection module, whether the optimal cloud service provider has failed, where determining further comprises detecting transient failures by performing multi-interval polling and differentiating between temporary delays and persistent service outages.

In some arrangements, the computer-implemented method includes dynamically rerouting, by the failover module, execution of the microservice to an alternate cloud service provider, where dynamically rerouting further comprises preemptively replicating execution state data across multiple cloud service providers to enable seamless stateful failover without re-executing the microservice from the initial request state.

In some arrangements, a computer-implemented method for dynamically selecting, executing, and optimizing microservices across multiple cloud service providers includes receiving, by a workload management system, a request for execution of a microservice, where the request includes input data and execution constraints. The method includes retrieving, by a microservices catalog stored in a memory of the workload management system, metadata associated with the microservice, where the metadata comprises a list of cloud service providers capable of executing the microservice, expected input and output formats, and compliance requirements. The method includes identifying, by a cloud provider selection engine of the workload management system, a set of available cloud service providers from the list of cloud service providers in the microservices catalog that meet predefined execution constraints, wherein the predefined execution constraints include execution cost, computational performance, security compliance, and geographical availability. The method includes retrieving, by a historical performance database of the workload management system, execution performance data for each cloud service provider in the set of available cloud service providers, where the execution performance data comprises prior execution times, error rates, response latencies, cost metrics, and real-time cloud provider resource availability including current CPU utilization, memory availability, network bandwidth, and active workload queues.

In some arrangements, the method includes evaluating, by an intelligent selection module of the workload management system, each cloud service provider in the set of available cloud service providers by applying a weighted cost function, where the weighted cost function is computed based on the execution performance data, execution cost, service availability, and predefined user constraints. The method includes dynamically adjusting, by the intelligent selection module, weight values in the weighted cost function based on historical workload trends, execution priority, and predefined service level agreement constraints.

The method includes selecting, by the intelligent selection module, an optimal cloud service provider for executing the microservice, where selecting further comprises excluding cloud service providers that have been flagged for security vulnerabilities or compliance violations within a predefined monitoring period. The method includes retrieving, by an application programming interface (API) abstraction layer of the workload management system, a cloud-specific API endpoint corresponding to the optimal cloud service provider, where the cloud-specific API endpoint is stored in a cloud provider registry of the workload management system. The method includes formatting, by the API abstraction layer, the request for execution of the microservice into a provider-specific API request, where the provider-specific API request conforms to an API specification of the optimal cloud service provider and wherein formatting further comprises applying protocol translation to adapt the request to one or more of REST, gRPC, WebSockets, GraphQL, or a provider-specific API format.

In some arrangements, the method includes encrypting, by a security module of the workload management system, the provider-specific API request using a secure encryption algorithm prior to transmission. The method includes transmitting, by the workload management system, the encrypted provider-specific API request to the optimal cloud service provider for execution. The method includes monitoring, by a performance monitoring module of the workload management system, an execution status of the microservice on the optimal cloud service provider, where monitoring comprises collecting execution time, response quality, resource utilization data, and detecting execution anomalies by analyzing response latencies, error codes, and resource consumption spikes using anomaly detection models.

The method includes storing, by the historical performance database, the execution time, response quality, and resource utilization data associated with the execution of the microservice for future workload optimization. The method includes analyzing, by a machine learning model stored in a memory of the workload management system, the execution time, response quality, and resource utilization data to identify patterns in cloud service performance trends, wherein the machine learning model is trained using a federated learning approach that updates the model using execution data from multiple distributed cloud environments without centralizing sensitive execution data.

In some arrangements, the method includes updating, by the workload management system, the weighted cost function based on predicted execution performance determined by the machine learning model. The method includes determining, by a fault detection module of the workload management system, whether the optimal cloud service provider has failed or is experiencing performance degradation based on a threshold deviation from historical execution performance, wherein determining further comprises detecting transient failures by performing multi-interval polling and differentiating between temporary delays and persistent service outages. The method includes, upon determining that the optimal cloud service provider has failed or is experiencing performance degradation, dynamically rerouting, by a failover module of the workload management system, execution of the microservice to an alternate cloud service provider selected based on an updated evaluation of the weighted cost function. The method includes preemptively replicating, by the failover module, execution state data across multiple cloud service providers to enable seamless stateful failover without re-executing the microservice from the initial request state. The method includes receiving, by the workload management system, a response from the optimal cloud service provider or the alternate cloud service provider, where the response comprises an output result generated by execution of the microservice. The method includes transmitting, by the workload management system, the output result to a requesting application.

In some arrangements, a system for dynamically selecting, executing, and optimizing microservices across multiple cloud service providers includes a workload management system configured to receive a request for execution of a microservice, where the request includes input data and execution constraints. The system includes a microservices catalog stored in a memory of the workload management system, where the microservices catalog is configured to store metadata associated with the microservice, the metadata comprising a list of cloud service providers capable of executing the microservice, expected input and output formats, and compliance requirements.

The system includes a cloud provider selection engine communicatively coupled to the workload management system, where the cloud provider selection engine is configured to identify a set of available cloud service providers from the list of cloud service providers in the microservices catalog that meet predefined execution constraints, wherein the predefined execution constraints include execution cost, computational performance, security compliance, and geographical availability. The system includes a historical performance database communicatively coupled to the workload management system, where the historical performance database is configured to retrieve execution performance data for each cloud service provider in the set of available cloud service providers, where the execution performance data comprises prior execution times, error rates, response latencies, cost metrics, and real-time cloud provider resource availability including current CPU utilization, memory availability, network bandwidth, and active workload queues.

In some arrangements, the system includes an intelligent selection module communicatively coupled to the workload management system, where the intelligent selection module is configured to evaluate each cloud service provider in the set of available cloud service providers by applying a weighted cost function, where the weighted cost function is computed based on the execution performance data, execution cost, service availability, and predefined user constraints. The intelligent selection module is further configured to dynamically adjust weight values in the weighted cost function based on historical workload trends, execution priority, and predefined service level agreement constraints.

The system includes a security compliance filter communicatively coupled to the workload management system, where the security compliance filter is configured to exclude from selection cloud service providers flagged for security vulnerabilities or compliance violations within a predefined monitoring period. The system includes an application programming interface (API) abstraction layer communicatively coupled to the workload management system, where the API abstraction layer is configured to retrieve a cloud-specific API endpoint corresponding to the optimal cloud service provider, wherein the cloud-specific API endpoint is stored in a cloud provider registry of the workload management system. The system includes a protocol translation module, a security module, a performance monitoring module, a fault detection module, a failover module, a state replication module, a response processing module, and a response transmission module, each configured to perform their respective functions to ensure optimal execution of microservices across multiple cloud service providers while maintaining security, efficiency, and fault tolerance.

In some arrangements, the system includes a historical performance database that is configured to store execution performance data categorized by time of day, day of the week, and seasonal trends to enable time-based optimization of cloud service provider selection. The categorization of execution performance data allows the system to adjust workload distribution dynamically based on historical patterns, ensuring that workload execution is optimized according to expected fluctuations in provider performance and cost.

In some arrangements, the system includes an intelligent selection module that is configured to assign priority weights to cloud service providers based on historical execution reliability, wherein higher priority is given to cloud service providers with lower failure rates and consistent performance over time. The assignment of priority weights ensures that cloud service providers with a track record of stability and efficiency are more likely to be selected for workload execution, reducing the risk of failures and performance degradation.

In some arrangements, the system includes an application programming interface (API) abstraction layer that is configured to cache provider-specific API request formats for cloud service providers that have been previously selected to reduce latency in generating subsequent execution requests. The caching mechanism eliminates redundant formatting operations and improves response time by allowing frequently used API requests to be retrieved from a pre-stored cache instead of being reformatted for each execution request.

In some arrangements, the system includes a machine learning model that is configured to detect long-term degradation trends in cloud service provider performance by analyzing historical execution data spanning multiple months and updating cloud provider rankings accordingly. The ability to detect long-term degradation trends enables the system to proactively adjust provider selection strategies, preventing workloads from being assigned to providers that exhibit a consistent decline in performance or reliability.

In some arrangements, the system includes a fault detection module that is configured to issue preemptive workload migration alerts when a cloud service provider exhibits execution performance degradation exceeding a predefined threshold over a rolling time window. The preemptive workload migration alerts allow the system to notify administrators and automatically initiate migration strategies before significant service disruptions occur, ensuring continuity of operations.

In some arrangements, the system includes a failover module that is configured to execute staged failover transitions, wherein workloads are gradually migrated from a failing cloud service provider to an alternate cloud service provider to prevent sudden load spikes and ensure a smooth transition. The staged failover transitions prevent abrupt shifts in processing loads that could cause overloading or service disruptions, ensuring a seamless failover process with minimal impact on execution performance. In some arrangements, the system includes a state replication module that is configured to synchronize execution state data using distributed ledger technology to ensure consistency and integrity of workload execution data across multiple cloud service providers. The use of distributed ledger technology enhances security and transparency, providing an immutable record of workload execution states while facilitating seamless transitions between cloud providers in failover scenarios.

In some arrangements, the system includes a response processing module that is configured to apply response validation rules to detect incomplete or erroneous execution results from cloud service providers and initiate re-execution of the microservice if necessary. The response validation rules ensure that execution results meet predefined quality and accuracy criteria, allowing the system to automatically correct errors by re-executing workloads that fail to meet expected output parameters.

The following description and claims, in conjunction with the drawings-all integral parts of this specification-will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates a microservices-based framework for dynamically selecting and executing workloads across multiple cloud service providers. The diagram depicts the interaction between applications, a centralized microservices catalog, a cloud vendor-specific API abstraction layer, an intelligent selection mechanism for optimal service execution, historical performance metrics storage, and multiple cloud service providers to ensure efficient, scalable, and cost-effective workload distribution.

FIG. 2 is an exemplary flow diagram in accordance with one or more embodiments disclosed herein that illustrates a method for dynamically selecting, executing, and optimizing microservices across multiple cloud service providers based on real-time performance metrics, cost analysis, security compliance, and machine learning-driven predictions. The flow diagram depicts the sequential operations performed by the workload management system, including receiving a microservice execution request, evaluating cloud service providers, formatting and transmitting execution requests, monitoring execution status, handling provider failures, and returning validated execution results to the requesting application.

FIG. 3A is an exemplary sequence diagram in accordance with one or more embodiments disclosed herein that illustrates the process of receiving a microservice execution request, retrieving microservice metadata, and selecting an optimal cloud service provider for execution. The workload management system interacts with the microservices catalog, cloud provider selection engine, and historical performance database to evaluate execution constraints, retrieve provider performance data, and apply a weighted cost function to identify the most suitable cloud service provider.

FIG. 3B is an exemplary sequence diagram in accordance with one or more embodiments disclosed herein that illustrates the formatting, encryption, and transmission of a microservice execution request to a selected cloud service provider. The API abstraction layer ensures compatibility with provider-specific API requirements, securely transmits the execution request, and initiates execution monitoring through the performance monitoring module.

FIG. 3C is an exemplary sequence diagram in accordance with one or more embodiments disclosed herein that illustrates the monitoring of execution performance, the application of machine learning-based optimization, and the detection and handling of execution failures. The fault detection module continuously evaluates execution metrics, triggers failover operations when provider failures occur, and ensures seamless workload migration through execution state replication and automatic rerouting to an alternate cloud provider.

FIG. 3D is an exemplary sequence diagram in accordance with one or more embodiments disclosed herein that illustrates the completion of microservice execution, response validation, and delivery of execution results to the requesting application. The response processing module verifies the integrity of the execution result, performs re-execution if necessary, and ensures that the final output is securely transmitted back to the requesting application.

FIG. 4 is an exemplary class diagram in accordance with one or more embodiments disclosed herein that illustrates the structural relationships and interactions between system components in the microservices-based simultaneous execution framework across multiple cloud service providers. The diagram defines the attributes, methods, and dependencies of each class, including the workload management system, microservices catalog, cloud provider selection engine, API abstraction layer, performance monitoring module, fault detection module, and failover module, ensuring dynamic workload distribution, execution optimization, and automated failover handling.

### DETAILED DESCRIPTION

The inventions provide systems and methods for dynamically selecting, executing, and optimizing microservices across multiple cloud service providers based on real-time performance, cost, and efficiency metrics. They introduce an intelligent, cloud-agnostic framework that enables seamless workload execution while continuously analyzing execution conditions to ensure optimal performance. The system is designed to allow applications to offload computing tasks to the most suitable cloud provider without requiring manual intervention, thereby optimizing execution efficiency, reducing costs, and ensuring high availability. The framework employs a microservices-based architecture that abstracts cloud provider dependencies, enabling a truly vendor-agnostic approach that allows workloads to be executed across different cloud environments seamlessly.

The invention includes a workload management system that acts as the central processing unit responsible for handling execution requests, selecting cloud service providers, formatting requests for provider-specific execution, monitoring execution status, and returning validated results to the requesting application. This system continuously optimizes workload execution by making data-driven decisions, leveraging historical performance data, and dynamically adjusting execution parameters based on real-time conditions. The workload management system also enforces execution constraints defined by applications, ensuring that workloads adhere to predefined performance, security, and cost requirements.

A microservices catalog serves as a structured repository that stores metadata about available microservices, including function descriptions, execution constraints, and supported cloud service providers. Applications query the microservices catalog to determine which services are available and how they can be executed within the multi-cloud environment. The catalog provides an interface that allows applications to request execution without needing to integrate directly with individual cloud providers. This approach simplifies application development and deployment by providing a standardized execution framework that abstracts provider-specific differences.

To determine the best cloud provider for executing a given workload, the system employs a cloud provider selection engine that evaluates cloud providers based on multiple selection criteria. This engine applies a weighted cost function that considers execution cost, computational performance, security compliance, and geographical availability to determine the optimal execution environment. The weighted cost function dynamically adjusts based on historical workload trends, execution priority, and predefined service level agreements, ensuring that execution decisions align with both business and technical objectives.

The historical performance database stores execution performance data collected over time, allowing the system to make data-driven provider selection decisions. This data includes prior execution times, error rates, response latencies, cost metrics, and real-time cloud provider resource availability such as CPU utilization, memory availability, network bandwidth, and active workload queues. By referencing historical execution data, the system can refine its provider selection model, ensuring that workloads are routed to the most efficient execution environment based on empirical performance insights.

A machine learning model enhances the decision-making process by analyzing historical execution data and identifying patterns in cloud service efficiency and cost fluctuations. The model continuously updates itself using federated learning techniques, enabling it to refine execution predictions without centralizing sensitive execution data. This predictive optimization allows the system to anticipate execution conditions and proactively adjust workload distribution strategies to improve performance and reduce costs. The machine learning model ensures that provider selection evolves over time, incorporating new data to improve the accuracy and efficiency of workload execution.

The API abstraction layer enables seamless communication between the workload management system and cloud service providers by translating execution requests into provider-specific API formats. This layer eliminates the need for applications to implement cloud provider-specific integrations, as all execution requests are automatically formatted to conform to the API specifications of the selected provider. The API abstraction layer supports multiple communication protocols, including REST, gRPC, WebSockets, and GraphQL, ensuring compatibility with a wide range of cloud service providers.

Once an execution request is formatted, it is securely transmitted to the selected cloud service provider, where it is executed according to the defined parameters. The performance monitoring module continuously tracks execution progress, collecting key performance metrics such as execution time, resource utilization, and error rates. If an execution deviates from expected performance thresholds, the system logs the anomaly for further analysis and may initiate corrective actions to maintain execution reliability.

A fault detection module ensures that execution failures or performance degradations are identified in real time. This module compares real-time execution metrics against historical benchmarks, detecting anomalies that indicate potential provider failures. If a cloud service provider exhibits execution performance degradation beyond a predefined threshold, the fault detection module triggers an alert and notifies the workload management system to initiate failover procedures.

When a failure or performance degradation is detected, the failover module dynamically reroutes execution to an alternate cloud service provider. The failover module selects the next best provider based on an updated evaluation of the weighted cost function, ensuring that execution continues without interruption. To enable seamless failover transitions, the failover module preemptively replicates execution state data across multiple cloud providers, preventing execution loss and reducing the need for re-execution from the beginning.

The response processing module ensures that execution results meet predefined quality standards before being delivered to the requesting application. Execution responses are validated against predefined criteria to detect incomplete or erroneous results. If the validation process detects execution anomalies, the system may trigger a re-execution process on an alternate cloud provider to correct errors. Once the execution response is successfully validated, it is forwarded to the requesting application, ensuring that the final output is accurate and complete.

The system provides an automated, intelligent, and optimized approach to multi-cloud microservices execution, enabling applications to leverage the advantages of multiple cloud providers without requiring manual provider selection or configuration. By dynamically selecting execution environments based on real-time conditions, the system ensures that workloads are executed in the most efficient, cost-effective, and secure manner. The use of historical performance data and machine learning-driven optimization enhances execution predictability, enabling continuous improvement of workload distribution strategies.

The system is designed to support a wide range of computational workloads, including real-time data processing, artificial intelligence inference, transactional analytics, and security-sensitive computations. It provides enterprises with a scalable and flexible cloud execution framework that allows workloads to be distributed dynamically across multiple providers, ensuring that execution constraints are met while optimizing resource utilization. The microservices-based architecture enables modular execution, allowing enterprises to integrate new cloud providers and execution policies without requiring major modifications to application logic.

By leveraging a distributed, cloud-agnostic execution model, the system enhances enterprise agility, enabling organizations to adapt to changing execution conditions while minimizing operational costs. The framework provides built-in resilience through automated failover mechanisms, ensuring high availability even in the event of cloud provider outages. The real-time performance monitoring and fault detection capabilities enable proactive workload management, reducing execution risks and maintaining service continuity.

The invention provides a robust, automated framework for optimizing microservices execution in multi-cloud environments. By integrating intelligent provider selection, real-time monitoring, machine learning-based optimization, and automated failover mechanisms, the system ensures that workloads are executed with the highest levels of efficiency, security, and reliability. The cloud-agnostic architecture enables enterprises to achieve seamless workload execution across different cloud providers while maintaining complete control over execution parameters. The continuous optimization mechanisms embedded in the system allow for long-term efficiency gains, ensuring that enterprises benefit from cost-effective, high-performance cloud computing solutions.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

There are several types of artificial intelligence that are applicable to implementing one or more aspects of the invention. Each type of artificial intelligence plays a role in optimizing execution efficiency, selecting the most suitable cloud service provider, monitoring performance, detecting faults, and automating workload distribution. The following sections describe these types of artificial intelligence, their relevance to the invention, and examples of specific AI models and frameworks that could be used.

Machine learning is a type of artificial intelligence that allows systems to learn from historical data and improve decision-making without being explicitly programmed. In the context of the invention, machine learning is applicable to optimizing cloud provider selection, refining workload distribution strategies, and continuously improving execution efficiency. By analyzing historical execution performance, cost trends, and service availability data, machine learning models can predict which cloud provider will offer the best execution conditions for a given microservice. The system can use supervised learning models, such as decision trees, support vector machines, or gradient boosting algorithms, to predict execution performance based on past executions. Additionally, reinforcement learning can be used to dynamically adjust execution parameters in real-time, ensuring that workloads are distributed optimally. Examples of machine learning frameworks that could be used include TensorFlow, Scikit-learn, and XGBoost.

Deep learning is a subset of machine learning that involves artificial neural networks with multiple layers of interconnected nodes. Deep learning is applicable to optimizing execution predictions by identifying complex patterns in cloud provider performance, latency, and cost fluctuations. Convolutional neural networks (CNNs) and recurrent neural networks (RNNs) can be used to process time-series data related to cloud service performance, allowing the system to detect patterns that may not be apparent through traditional statistical analysis. Transformer-based models, such as BERT or GPT, can be used to analyze execution logs and generate insights about workload distribution strategies. Deep learning is particularly useful for scenarios where execution data is highly complex, requiring the system to learn intricate relationships between different execution parameters. Frameworks such as PyTorch and TensorFlow could be used to implement deep learning models for optimizing workload execution.

Federated learning is a distributed machine learning technique that allows multiple devices or systems to train a model collaboratively without sharing raw data. This type of artificial intelligence is applicable to the invention's machine learning optimization mechanism, as it enables execution performance data to be processed across multiple cloud environments without centralizing sensitive information. Federated learning ensures data privacy by keeping execution logs within each cloud provider's environment while still allowing the system to learn from distributed execution patterns. This approach is particularly relevant in scenarios where execution performance data is sensitive and cannot be shared across cloud providers due to regulatory or compliance requirements. Examples of federated learning frameworks that could be used include TensorFlow Federated (TFF) and PySyft.

Reinforcement learning is an artificial intelligence technique in which an agent learns by interacting with an environment and receiving feedback in the form of rewards or consequences. In the context of the invention, reinforcement learning is applicable to dynamically adjusting cloud provider selection strategies based on real-time execution performance. The system can continuously refine its decision-making process by assigning rewards to cloud providers that meet performance and cost objectives while penalizing providers that exhibit execution failures or cost inefficiencies. Reinforcement learning is particularly useful for fine-tuning execution parameters in real-time, ensuring that workloads are always assigned to the most optimal execution environment. Examples of reinforcement learning frameworks that could be used include OpenAI's Gym, Stable Baselines3, and DeepMind's Acme.

Anomaly detection is a subset of artificial intelligence focused on identifying unusual patterns in data that do not conform to expected behavior. This is applicable to the invention's fault detection module, which continuously monitors execution performance and detects provider failures or performance degradation. Anomaly detection techniques, such as autoencoders, isolation forests, and one-class SVMs, can be used to identify deviations from normal execution behavior. By detecting anomalies in execution latency, error rates, or cost fluctuations, the system can proactively trigger failover mechanisms and reroute workloads before performance degradation impacts execution results. Examples of anomaly detection frameworks that could be used include PyCaret, Scikit-learn, and Amazon Lookout for Metrics.

Natural language processing (NLP) is a type of artificial intelligence that enables systems to understand and process human language. NLP is applicable to analyzing execution logs, identifying patterns in cloud provider documentation, and automating the processing of unstructured text-based execution reports. The system can use NLP to extract insights from cloud provider service agreements, optimize workload execution policies, and enhance decision-making based on historical execution reports. Transformer-based NLP models, such as BERT and GPT-4, could be used to analyze cloud provider logs and recommend execution optimizations. Examples of NLP frameworks that could be used include Hugging Face's Transformers, SpaCy, and Google's Cloud Natural Language API.

Graph-based artificial intelligence, including graph neural networks (GNNs), is applicable to modeling relationships between cloud service providers, execution parameters, and workload dependencies. The invention can use graph-based AI to analyze the network of interactions between different microservices, cloud provider execution nodes, and execution constraints. By constructing a graph representation of execution performance data, the system can optimize workload routing based on historical and real-time execution conditions. Graph AI is particularly useful for identifying execution bottlenecks and optimizing workload transitions in complex multi-cloud environments. Examples of graph-based AI frameworks that could be used include Deep Graph Library (DGL), PyTorch Geometric, and NetworkX.

Bayesian inference is a probabilistic modeling technique that updates beliefs based on new data. This type of artificial intelligence is applicable to refining the execution selection process by incorporating uncertainty into decision-making. Bayesian models allow the system to continuously update its understanding of cloud provider performance, adapting to fluctuations in execution conditions. The system can use Bayesian optimization to fine-tune workload execution parameters, ensuring that execution constraints are met while minimizing cost and latency. Examples of Bayesian inference frameworks that could be used include PyMC3, Edward, and Scikit-optimize.

Genetic algorithms are a type of artificial intelligence inspired by evolutionary biology that optimize solutions through selection, crossover, and mutation. This technique is applicable to optimizing cloud provider selection and execution parameters by iteratively evolving execution strategies. The system can use genetic algorithms to explore different execution configurations and identify the most efficient workload distribution strategy. Genetic algorithms are particularly useful for optimizing execution efficiency when multiple conflicting objectives, such as cost and performance, need to be balanced. Examples of genetic algorithm frameworks that could be used include DEAP, GeneticSharp, and Inspyred.

Transfer learning is a machine learning technique that enables a model trained on one task to be adapted for a different but related task. In the context of the invention, transfer learning is applicable to adapting execution prediction models trained on one set of workloads to optimize execution strategies for new microservices. By leveraging previously learned execution patterns, the system can reduce the need for extensive retraining when introducing new execution parameters. Transfer learning is particularly useful for accelerating workload optimization in environments where execution conditions change frequently. Examples of transfer learning frameworks that could be used include TensorFlow Hub, PyTorch's Transfer Learning API, and Hugging Face's Model Hub.

By integrating these types of artificial intelligence into different aspects of the invention, the system ensures that microservice execution is continuously optimized, dynamically managed, and resilient to failures. Each type of AI contributes to improving execution performance, automating provider selection, monitoring workload efficiency, and maintaining seamless failover transitions. The combination of machine learning, deep learning, federated learning, reinforcement learning, anomaly detection, NLP, graph-based AI, Bayesian inference, genetic algorithms, and transfer learning enables the system to intelligently distribute workloads across multiple cloud service providers while ensuring compliance with cost, security, and performance requirements.

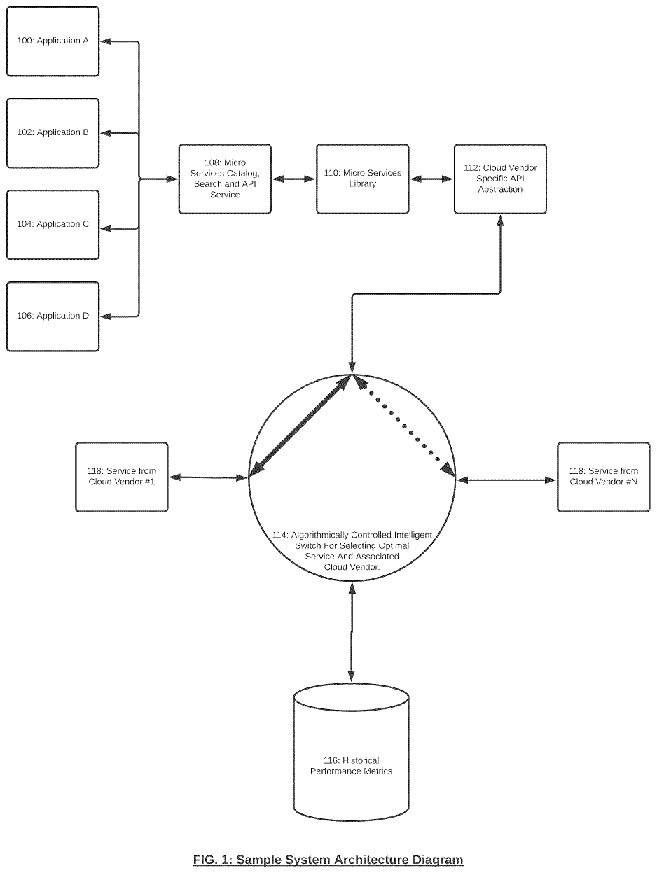

FIG. 1 illustrates an exemplary system architecture diagram for a microservices-based simultaneous execution framework via multiple cloud service providers. The system architecture consists of multiple applications, a centralized microservices catalog, a structured microservices library, a cloud vendor-specific API abstraction layer, an algorithmically controlled intelligent switch for workload distribution, historical performance metrics storage, and multiple cloud service providers for execution. The architecture enables dynamic selection, execution, and optimization of workloads across multiple cloud service providers, ensuring that execution is efficient, cost-effective, and adaptable to changing execution conditions.

Application A (100), Application B (102), Application C (104), and Application D (106) represent distinct software applications, services, or computational systems that require microservices to execute workloads. These applications could be financial analytics tools, fraud detection systems, machine learning inference engines, real-time monitoring platforms, big data processing applications, or transaction processing systems. Each application submits microservice execution requests to the system based on specific computational needs, such as sorting, filtering, encryption, artificial intelligence model inference, or other cloud-executable tasks. These applications communicate with the system using standardized request formats that specify execution parameters such as data input, performance constraints, security requirements, cost preferences, and compliance mandates. The applications do not need to be aware of the cloud provider that will execute the microservice, as the system dynamically determines and assigns execution based on real-time optimization metrics.

The microservices catalog, search, and API service (108) functions as a centralized repository that stores metadata about available microservices. This component allows applications to search for and request microservices without needing to integrate directly with specific cloud providers. The catalog maintains structured records for each microservice, including function descriptions, expected input and output parameters, available cloud execution environments, versioning information, and security compliance requirements. For example, an application requesting a sorting algorithm would query the microservices catalog to determine which cloud providers support sorting functions and what API specifications must be followed to invoke those functions. The catalog enables discovery of microservices in a vendor-agnostic manner, ensuring that applications can access execution capabilities across multiple cloud platforms seamlessly.

The microservices library (110) is a structured collection of reusable microservices designed to be executed across multiple cloud service providers. This library contains predefined functions that can be dynamically invoked by applications, allowing workloads to be modular, scalable, and optimized for execution across different environments. Each microservice in the library follows a standardized architecture that abstracts vendor-specific dependencies, ensuring interoperability between applications and cloud execution environments. For instance, microservices within the library could include data transformation functions, security operations such as encryption and decryption, machine learning inference models, and real-time analytics computations. The microservices library ensures that workloads remain portable and cloud-agnostic while benefiting from the execution efficiencies provided by different cloud vendors.

The cloud vendor-specific API abstraction layer (112) acts as a middleware component that standardizes interactions between applications and cloud service providers. Since different cloud vendors expose their services through distinct API structures, authentication mechanisms, and communication protocols, this layer ensures that microservice requests are formatted correctly for each provider. The API abstraction layer translates requests into the appropriate format based on provider-specific API requirements, allowing seamless integration with multiple cloud services. For example, if an application submits a request to execute a deep learning inference model, the API abstraction layer converts the request into an execution format compatible with cloud-based AI inference engines such as AWS SageMaker, Google Cloud AI Platform, or Azure Machine Learning. The abstraction layer eliminates the need for applications to maintain separate integrations for each cloud provider, simplifying multi-cloud execution management.

An algorithmically controlled intelligent switch for selecting the optimal service and associated cloud vendor (114) serves as the system's core decision-making component. This intelligent switch dynamically evaluates multiple cloud execution environments and selects the most suitable execution platform based on real-time conditions. The selection process involves analyzing factors such as cloud service availability, execution cost, historical performance data, network latency, regulatory compliance, and security considerations. The intelligent switch continuously monitors execution environments, adjusting selection criteria dynamically to ensure that workloads are executed in the most efficient and cost-effective manner. For example, if an AI model inference service is requested, the intelligent switch may determine that Google Cloud TPU accelerators offer the lowest cost and highest efficiency at the time of execution, whereas AWS GPU instances may provide better scalability for large workloads. The intelligent switch optimizes execution assignments in real time, ensuring optimal workload distribution.

Historical performance metrics storage (116) maintains execution logs, tracking data for previous microservice executions, and provider performance over time. This storage module records key metrics such as execution times, response latencies, failure rates, resource utilization, and cost efficiency for each cloud service provider. The historical performance database enables data-driven optimization by allowing the intelligent switch to reference past execution trends when selecting providers. For example, if a cloud provider has shown recurring performance degradation during peak usage hours, the system may deprioritize that provider during those times. By leveraging historical data, the system ensures that execution decisions are based on empirical evidence rather than static configurations.

Services from Cloud Vendor #1 (118) and Cloud Vendor N (118) represent multiple cloud execution environments that support the execution of microservices. The system dynamically routes workloads to different cloud providers based on real-time performance and cost analysis. These cloud vendors may include public cloud platforms such as Amazon Web Services (AWS), Microsoft Azure, Google Cloud Platform (GCP), IBM Cloud, and other specialized cloud service providers. Each cloud vendor provides execution environments with varying performance characteristics, pricing structures, and regional availability. For example, AWS may provide serverless computing capabilities through AWS Lambda, while Google Cloud Functions and Azure Functions offer equivalent services in their respective ecosystems. The system ensures that microservices are routed to the best available cloud provider based on current execution conditions.

When an application submits a request for microservice execution, the system first queries the microservices catalog to locate the most suitable microservice implementation. Once a microservice is identified, the system evaluates cloud vendor performance, cost, and availability using the intelligent switch. The request is then formatted into a provider-specific API call via the API abstraction layer before being transmitted to the selected cloud provider. During execution, the system continuously monitors workload performance, logs execution data into the historical performance database, and dynamically reassigns workloads if performance degradation or cost fluctuations occur. If a cloud provider experiences failure or degraded performance, the system automatically triggers a failover, rerouting execution to an alternate provider to ensure continuous availability.

The architecture of FIG. 1 enables enterprises to leverage a multi-cloud strategy without requiring applications to be directly integrated with individual cloud providers. The intelligent workload distribution mechanism ensures cost-efficient execution, optimized performance, and compliance with security and regulatory requirements. The modular nature of the microservices library and API abstraction layer allows enterprises to adopt new cloud platforms or integrate additional execution environments without modifying application logic. By dynamically selecting execution environments based on real-time conditions, the system provides a scalable and adaptable framework for executing microservices across multiple cloud providers. This approach enhances computational efficiency, reduces operational costs, and enables seamless multi-cloud workload execution.

The optimization process works by analyzing and traversing multiple relationship tables and matrices that provide a structured way to evaluate cloud vendor availability, cost, and historical execution performance. The system dynamically selects the most suitable cloud vendor for executing a given microservice based on a weighted decision model that considers execution efficiency, cost-effectiveness, and provider availability. Samples are shown below for reference.

The Availability Matrix provides insights into which cloud vendors support specific services. Each cloud vendor has different execution capabilities, and some vendors may not support certain services at all. For example, if a workload requires Service A, the matrix shows that Cloud Vendor 1 does not support it, while Cloud Vendor 2 and Cloud Vendor 3 do, with Cloud Vendor 2 ranked as the most efficient provider for Service A. Similarly, for Service B, Cloud Vendor 1 is the highest-ranked provider, meaning it has demonstrated the best performance or most suitable execution environment for that service. The system uses this matrix to filter out cloud providers that cannot support the requested service before proceeding with cost evaluation.

TABLE 1
Availability Matrix

| | Service A | Service B | Service C | Service D |
|---|---|---|---|---|
| Cloud Vendor 1 | Not available | Rank 1 | Rank 3 | Rank 1 |
| Cloud Vendor 2 | Rank 1 | Rank 2 | Rank 2 | Not Available |
| Cloud Vendor 3 | Rank 2 | Rank 3 | Rank 1 | Not Available |

The Current Cost Matrix provides execution pricing information for each cloud vendor per CPU hour. This matrix is critical in ensuring cost optimization while maintaining high execution efficiency. For example, if Service B is required, Cloud Vendor 1 offers it at $5 per CPU hour, while Cloud Vendor 2 offers the same service at $1 per CPU hour, making Cloud Vendor 2 the most cost-effective option. Similarly, if a workload requires Service C, Cloud Vendor 3 offers it at $1 per CPU hour, making it a more economical choice than Cloud Vendor 2, which charges $10 per CPU hour. The system calculates the total estimated execution cost by multiplying the per-hour pricing with the estimated execution time and resources required for processing.

TABLE 2
Current Cost Matrix

| | Service A | Service B | Service C | Service D |
|---|---|---|---|---|
| Cloud | Not available | $5/CPUHR | $5/CPUHR | $100/CPUHR |
| Vendor 1 | | | | |
| Cloud | $4/CPUHR | $1/CPUHR | $10/CPUHR | Not available |
| Vendor 2 | | | | |
| Cloud | $10/CPUHR | $1/CPUHR | $1/CPUHR | Not available |
| Vendor 3 | | | | |

The Historical Cost and Performance Data Matrix introduces an additional layer of decision-making by incorporating past execution trends into the selection process. This matrix provides execution patterns across different times and days, allowing the system to predict the most efficient time to execute a workload. For example, historical data may show that Factor A (which could represent network latency or server congestion) is significantly lower on Monday at 10 AM, indicating a preferable execution window. Similarly, if Factor C (such as execution error rates) is highest on Wednesday at 11 PM, the system may avoid scheduling workloads during this period due to a higher likelihood of performance degradation. The system integrates historical execution insights into real-time decision-making, allowing it to anticipate fluctuations in cloud service efficiency and dynamically adjust execution strategies.

TABLE 3
Historic Data for the Current Cost Matrix

| | Factor A | Factor B | Factor C | Factor D |
|---|---|---|---|---|
| Row 1 | 10 | 14 | Monday | 10 a.m. |
| Row 2 | 23 | 189 | Tuesday | 11 a.m. |
| Row 3 | 45 | 35 | Wednesday | 11 p.m. |

The optimization process follows a step-by-step traversal of these matrices to determine the best execution path. First, the system retrieves the Availability Matrix to filter out cloud vendors that do not support the requested service. Next, it references the Current Cost Matrix to evaluate execution costs among the remaining vendors, selecting the provider with the lowest cost while meeting execution constraints. Finally, the system cross-references the Historical Cost and Performance Data Matrix to refine the selection further, ensuring that the workload is scheduled at an optimal time when past performance data suggests peak efficiency.

The intelligent selection module applies a weighted cost function that assigns scores to each provider based on real-time execution parameters. The system dynamically adjusts the weight of cost, performance, and availability factors based on the nature of the requested service. If the workload is latency-sensitive, execution speed and response time are weighted more heavily. If cost savings are a priority, providers with lower per-hour execution pricing receive higher preference. The optimization engine continuously refines the cost function using machine learning models trained on past execution data, allowing for improved prediction of workload distribution strategies. Once an optimal provider has been selected, the system formats the execution request using a cloud provider-specific API, encrypts the request for secure transmission, and submits it to the selected cloud vendor. The Performance Monitoring Module then tracks execution status in real time, logging execution time, cost, and service reliability metrics back into the Historical Performance Database. If the cloud vendor experiences degradation during execution, the Fault Detection Module triggers a Failover Event, selecting the next-best provider from the Availability and Cost Matrices and rerouting execution to maintain continuity.

By continuously referencing and updating these relationship tables and matrices, the system ensures that microservice execution is both cost-efficient and performance-optimized, leveraging real-time and historical data to make intelligent workload execution decisions.

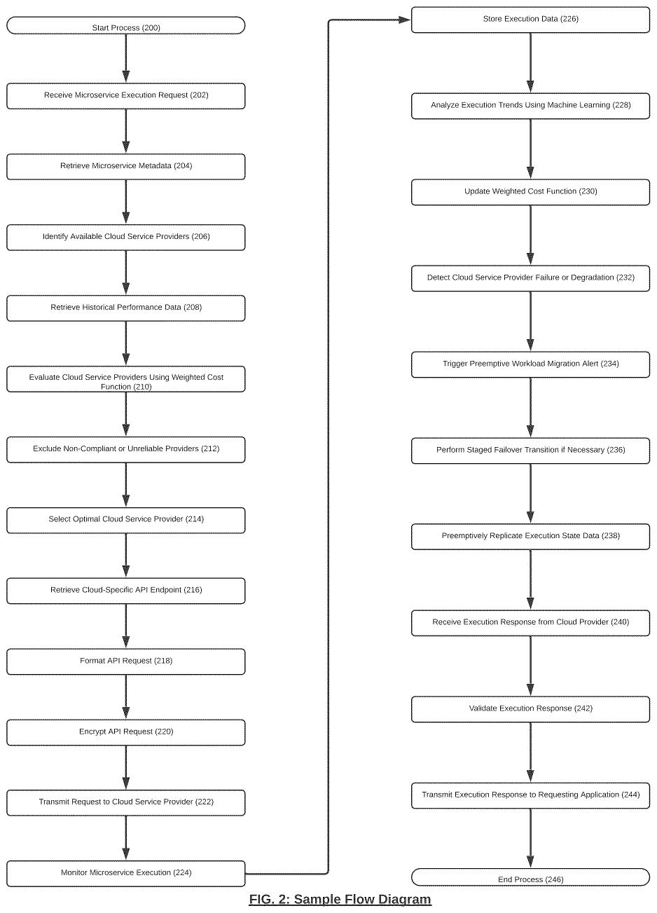

FIG. 2 illustrates an exemplary flow diagram of the method for dynamically selecting, executing, and optimizing microservices across multiple cloud service providers. The process begins when the system is initialized and enters an operational state where it is actively monitoring for incoming execution requests. The workload management system receives a request for execution of a microservice from an external application or system. The request includes input data and execution constraints such as execution priority, cost thresholds, compliance requirements, performance targets, and any other business or technical parameters required for intelligent execution routing (200). Upon receiving the request, the workload management system initiates processing by querying the microservices catalog, a structured database stored in memory, to retrieve metadata associated with the requested microservice. The metadata includes a list of cloud service providers that are capable of executing the microservice, expected input and output formats, and any compliance requirements that must be satisfied for execution to be valid (202).

Once the microservice metadata has been retrieved, the cloud provider selection engine activates to determine an optimal execution environment. The selection engine identifies a set of available cloud service providers from the list of providers stored in the microservices catalog. The selection is performed by evaluating execution constraints, which include execution cost, computational performance, security compliance, and geographical availability. Execution cost factors may include direct pricing models from cloud providers, demand-based fluctuations, and long-term trends in provider billing rates. Computational performance factors include real-time availability of compute resources, efficiency in executing similar workloads, and the ability to meet predefined performance benchmarks. Security compliance factors include whether a provider meets jurisdictional regulations, encryption standards, and authentication protocols required by the organization. Geographical availability ensures that execution occurs in an optimal region that satisfies both latency requirements and data sovereignty regulations (204).

To further refine provider selection, the system retrieves execution performance data from a historical performance database. This database stores execution logs, monitoring data, and past interactions between microservices and cloud providers to build a profile of provider reliability. The retrieved performance data includes prior execution times, error rates, response latencies, cost metrics, and real-time cloud provider resource availability. The real-time resource availability retrieval process involves querying live performance data from cloud providers, including current CPU utilization, memory availability, network bandwidth, and active workload queues. These factors help determine whether a cloud provider has the immediate capacity to execute the requested microservice efficiently and within the constraints of the execution request (206).

With historical and real-time performance data available, the intelligent selection module applies a weighted cost function to evaluate each cloud service provider. This function assigns relative importance to execution cost, provider performance, availability, and compliance parameters. The weighting of these values can dynamically adjust based on workload trends, execution priority, and predefined service level agreements. For example, workloads requiring real-time execution may increase the weighting of provider response latency and availability, while cost-sensitive workloads may prioritize selecting the lowest-priced provider. The dynamic nature of this cost function allows the system to adapt to changing business needs and optimize cloud provider selection with evolving execution conditions (208).

After completing the cost function evaluation, the system performs security and compliance filtering to exclude cloud providers that are flagged as unreliable, non-compliant, or subject to security vulnerabilities. This step involves checking the provider's history against a predefined security database, reviewing any compliance violations reported by industry regulators, and removing providers that fail to meet threshold security ratings. Providers that have experienced frequent failures, poor data encryption practices, or unresolved security incidents are removed from the selection pool before a final decision is made (210).

The intelligent selection module then determines the optimal cloud service provider by selecting the provider with the lowest computed value from the weighted cost function. The selected provider is deemed the most suitable for execution based on a balance of efficiency, security, cost, and reliability (212). Following this decision, the system retrieves the cloud-specific API endpoint associated with the selected cloud provider from the cloud provider registry. This ensures that the execution request is directed to the correct interface and that the system can interact with the provider using the correct API format (214).

To facilitate provider-specific execution, the API abstraction layer formats the request into a provider-specific API request. This step translates the request into the appropriate API format required by the selected provider, which may include REST, gRPC, WebSockets, GraphQL, or a provider-specific communication protocol. The formatting ensures that the microservice execution request is compatible with the selected provider and can be processed without modification. If necessary, the system uses a protocol translation module to convert the request into a different transport format to align with provider-specific execution constraints (216).

The security module then encrypts the API request using a secure encryption algorithm before transmission. This encryption ensures that sensitive execution data remains protected during transport and that unauthorized third parties cannot intercept or modify the request. The encrypted API request is then transmitted by the transmission module to the selected cloud service provider for execution (218).

During execution, the performance monitoring module actively tracks the execution status of the microservice on the cloud service provider. The monitoring process involves collecting execution time, response quality, resource utilization data, and detecting anomalies. Anomaly detection mechanisms analyze response latencies, error codes, and unexpected resource spikes to identify irregularities that may impact execution efficiency. If anomalies are detected, the system logs the event for further analysis and may initiate corrective measures (220).

Upon completion of execution, the system stores the execution time, response quality, and resource utilization data in the historical performance database. This data is used for future optimization and trend analysis (222). The machine learning model then processes the stored execution data to identify performance trends and update future provider selection strategies. The machine learning model utilizes federated learning techniques to update itself using distributed execution data while maintaining data privacy by avoiding centralization of sensitive workload logs (224).

The workload management system then updates the weighted cost function using the insights generated by the machine learning model. This step refines the provider selection process for future execution requests and improves prediction accuracy in workload allocation (226). The fault detection module then determines whether the selected cloud provider has failed or is experiencing degradation. This module performs multi-interval polling to differentiate between transient failures and persistent provider outages. If a provider's performance falls below an acceptable threshold, the module logs the event and notifies the workload management system (228).

If performance degradation is detected, the fault detection module issues a preemptive workload migration alert, informing the system and administrators that the provider is at risk of failure. This alert allows the system to prepare for failover if necessary (230). If failover is required, the failover module dynamically reroutes execution to an alternate cloud service provider, using the updated weighted cost function to select the next best provider. To ensure a smooth transition, the system implements staged failover, where workloads are gradually shifted between providers to prevent sudden load spikes or service interruptions (232).

The state replication module preemptively synchronizes execution state data across multiple cloud providers to enable seamless failover. This ensures that in-progress workloads can be resumed on alternate providers without re-execution from the initial request state. In some cases, distributed ledger technology is used to maintain execution state integrity across providers (234).

Once execution completes, the response processing module receives the execution result from the optimal or alternate cloud provider. The response is validated to detect incomplete or erroneous outputs. If validation fails, the system may initiate re-execution of the microservice to correct errors (236). After validation, the response transmission module delivers the final execution result to the requesting application, completing the process (238). Finally, all execution data is logged for historical tracking and future performance optimizations (240). The system then returns to an idle state, ready to process the next execution request (242).

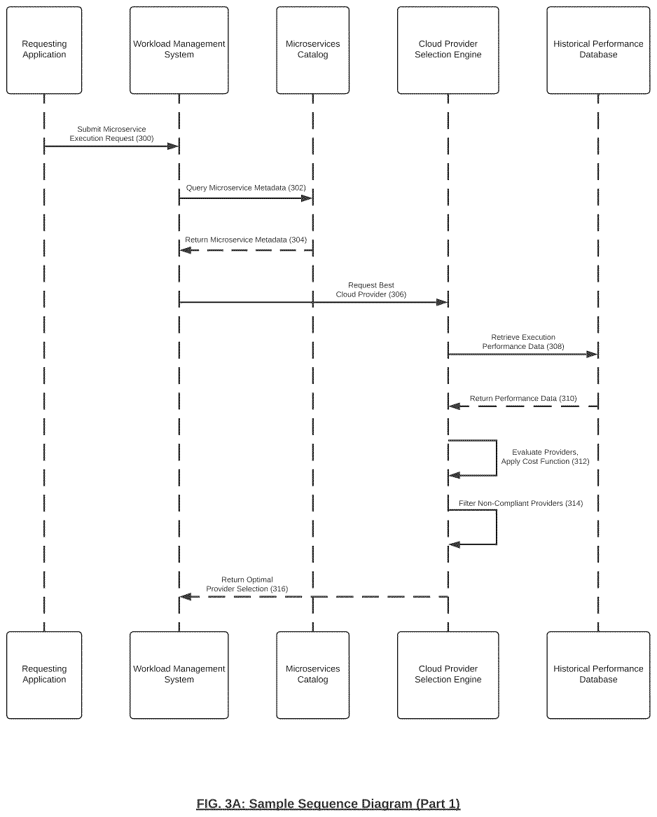

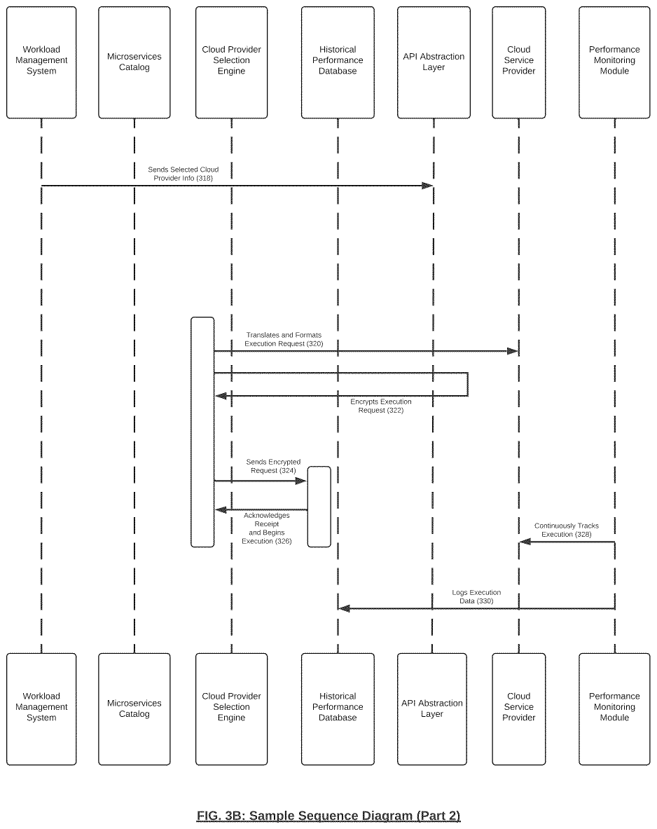

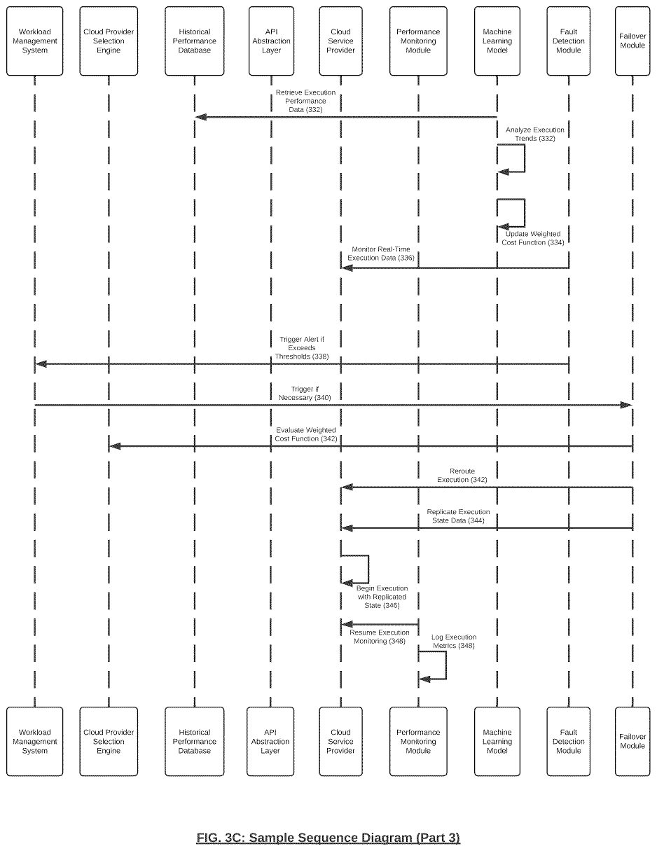

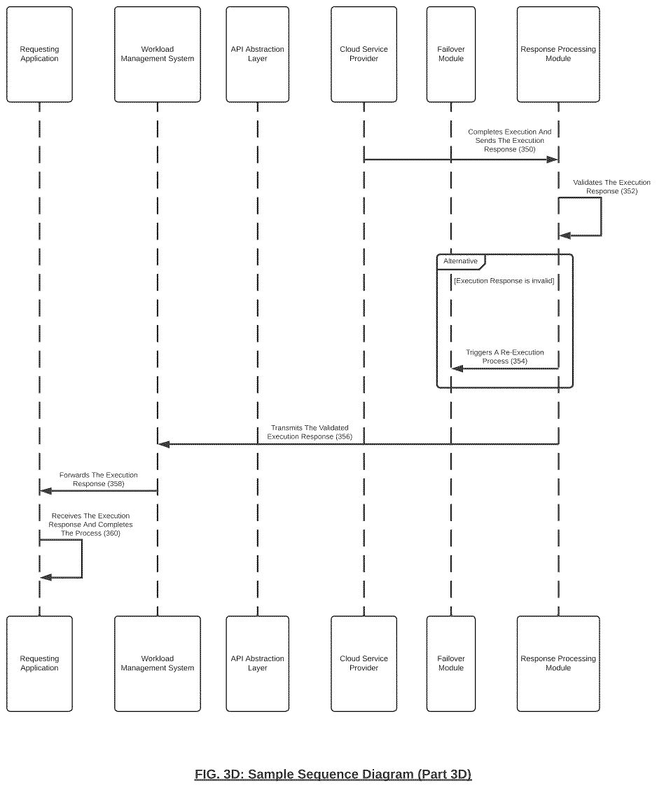

FIGS. 3A-3D collectively illustrate a detailed sequence of interactions between system components to dynamically select, execute, monitor, and optimize microservices across multiple cloud service providers. The sequence diagram captures every step of the execution process, ensuring that workloads are efficiently distributed while maintaining high performance, security, and cost-effectiveness. The system components work together seamlessly to provide a robust and automated approach to managing microservices execution across multiple cloud environments.

In FIG. 3A, the sequence begins when the requesting application submits a microservice execution request to the workload management system (300). The request includes input data required for execution, as well as execution constraints that specify requirements related to performance, security, cost, and compliance. Execution constraints may include maximum allowable latency, minimum throughput requirements, data processing locations to comply with regulatory requirements, encryption standards, and predefined cost thresholds to ensure cost-effective execution. Upon receiving the request, the workload management system initiates the execution process by querying the microservices catalog to retrieve metadata about the requested microservice (302). The microservices catalog is a structured repository that maintains records for each available microservice, including a list of compatible cloud service providers, expected input and output formats, compliance requirements, versioning information, and execution dependencies. The catalog enables the system to identify which cloud providers can support the requested microservice execution. The microservices catalog retrieves the relevant metadata and sends it back to the workload management system for further processing (304).

With the metadata retrieved, the workload management system proceeds to the cloud provider selection process. The workload management system sends a request to the cloud provider selection engine to determine the most suitable cloud provider for executing the microservice based on the execution constraints provided by the requesting application (306). The cloud provider selection engine is responsible for identifying optimal execution environments by evaluating real-time cloud performance metrics, historical execution data, and cost efficiency. To make an informed decision, the cloud provider selection engine queries the historical performance database to retrieve execution performance data associated with each cloud provider, including prior execution times, failure rates, response latencies, resource availability, and cost trends (308). The historical performance database maintains a continuously updated log of execution results, ensuring that the cloud provider selection engine has access to comprehensive data for decision-making. The historical performance database retrieves the requested execution performance data and transmits it to the cloud provider selection engine for analysis (310).

The cloud provider selection engine applies a weighted cost function to evaluate each cloud provider, factoring in execution performance data, execution cost, service availability, security compliance, and user-defined constraints (312). The weighted cost function is dynamically adjusted based on historical workload trends, execution priority, and predefined service level agreements to ensure that selection decisions align with both business and technical objectives. For example, if an application requires low-latency execution, the weighted cost function increases the importance of cloud providers with faster response times while reducing the weight assigned to cost considerations. The cloud provider selection engine further applies a security compliance filter to exclude cloud providers that have been flagged for security vulnerabilities, compliance violations, or instability within a predefined monitoring period (314). By filtering out unreliable or non-compliant providers, the system ensures that execution occurs in a secure and trusted environment. After evaluating the weighted cost function and filtering out non-compliant providers, the cloud provider selection engine selects the optimal cloud service provider and returns the selection decision to the workload management system (316).

In FIG. 3B, after the optimal cloud provider has been selected, the workload management system sends the selected cloud provider information to the API abstraction layer to format the execution request for transmission (318). The API abstraction layer is responsible for ensuring that microservice execution requests conform to the provider-specific API specifications required for execution. The API abstraction layer translates the request into a provider-specific API request format, ensuring compatibility with the cloud provider's execution platform (320). The API abstraction layer also determines whether the request must be formatted as a REST request, gRPC request, WebSockets request, GraphQL request, or another communication protocol based on the cloud provider's API specifications. The translated request is then encrypted by the API abstraction layer using a secure encryption algorithm to protect the integrity of the data being transmitted (322). Encryption ensures that sensitive execution data remains secure during transport between the workload management system and the cloud provider. After encryption is completed, the API abstraction layer transmits the encrypted request to the selected cloud service provider for execution (324).

Once the encrypted request is received, the cloud service provider acknowledges receipt and begins execution of the microservice (326). The execution process may involve running computations, analyzing data, or performing machine learning inference depending on the nature of the microservice being executed. While execution is in progress, the performance monitoring module continuously tracks the execution status in real-time, collecting data related to execution time, response latency, resource utilization, and potential anomalies (328). The collected execution data is stored in the historical performance database to support future optimization and provider selection processes (330). The performance monitoring module ensures that execution remains within expected thresholds, detecting any deviations that may indicate performance issues.

In FIG. 3C, the machine learning model retrieves execution performance data from the historical performance database and analyzes trends to identify patterns in cloud service efficiency and cost fluctuations (332). The machine learning model continuously refines its prediction algorithms, enabling the workload management system to improve provider selection decisions over time. Based on the insights generated from the execution data, the machine learning model updates the weighted cost function to improve the accuracy of future provider selection processes (334). Meanwhile, the fault detection module monitors execution performance in real time to detect cloud service failures or significant performance degradations (336). If execution metrics exceed acceptable thresholds, the fault detection module triggers an alert indicating that a failure or degradation has been detected (338).

Upon receiving the fault alert, the workload management system invokes the failover module to initiate corrective action (340). The failover module dynamically reroutes execution to an alternate cloud service provider based on an updated evaluation of the weighted cost function (342). To ensure that execution continuity is maintained, the failover module preemptively replicates execution state data across multiple cloud service providers, allowing failover transitions to occur seamlessly without requiring execution to restart from the beginning (344). The newly selected cloud service provider begins executing the microservice using the replicated execution state, ensuring minimal disruption to workload processing (346). The performance monitoring module resumes tracking execution performance on the alternate provider and logs execution data for future analysis (348).

In FIG. 3D, after execution is completed, the cloud service provider sends the execution response to the response processing module for validation (350). The response processing module applies validation rules to ensure that the execution result is complete, accurate, and meets predefined quality standards (352). If the response validation process detects errors or incomplete execution results, the response processing module triggers a re-execution process on an alternate cloud service provider to correct the issue (354). Once the response is successfully validated, the response processing module transmits the execution response to the workload management system (356). The workload management system forwards the validated execution response to the requesting application, completing the microservice execution process (358). The requesting application receives the execution response, ensuring that the workload has been successfully processed and that the requested computation has been performed accurately (360).

The comprehensive sequence of operations detailed in FIGS. 3A-3DD ensures that microservice execution is dynamically optimized, resilient to failures, and aligned with cost and performance constraints. The workload management system, in coordination with the cloud provider selection engine, API abstraction layer, and machine learning model, continuously refines execution strategies and optimizes workload routing based on historical and real-time execution data. The performance monitoring module ensures execution reliability, while the fault detection and failover modules maintain system resilience by dynamically rerouting execution in response to provider failures or performance degradations. The response processing module guarantees data integrity by validating execution results before returning them to the requesting application. By leveraging a structured and intelligent execution framework, the system provides a scalable, adaptable, and efficient solution for multi-cloud microservices execution.

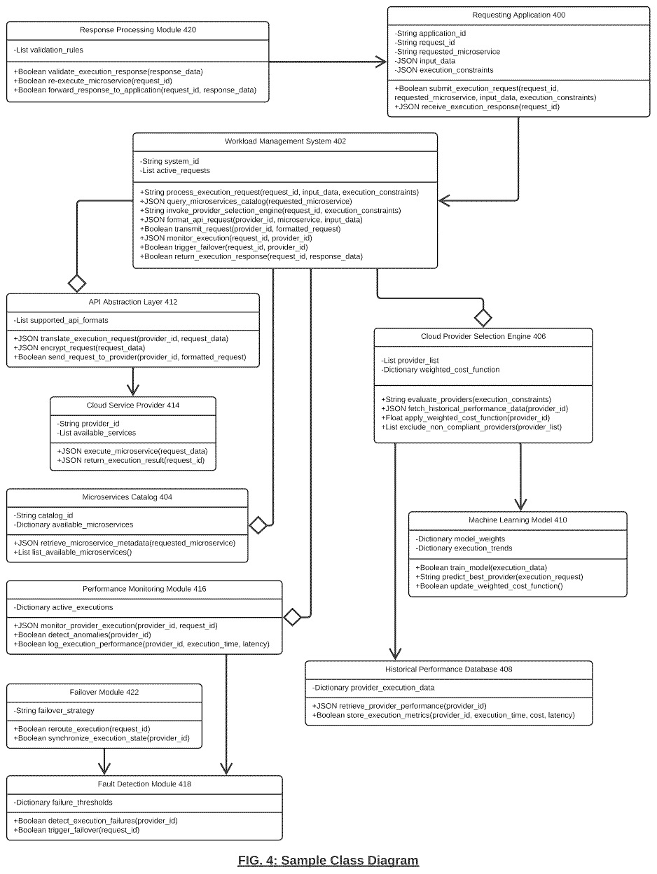

FIG. 4 illustrates an exemplary class diagram that defines the structural relationships and interactions between different system components in the microservices-based simultaneous execution framework across multiple cloud service providers. The class diagram consists of multiple interconnected classes, each representing a key functional component of the system. The relationships between these classes define how microservices execution requests are processed, how cloud providers are selected, how execution performance is monitored, and how failover mechanisms are triggered when necessary. The system enables the seamless and dynamic distribution of workloads across cloud service providers while optimizing cost, security, compliance, and execution efficiency.

The Requesting Application (400) class represents an external application, service, or system that submits microservice execution requests to the workload management system. This class includes attributes such as application_id, request_id, requested_microservice, input_data, and execution_constraints, which define the unique identification of the requesting application, the specific microservice being requested, the associated input data, and any execution constraints such as maximum latency, compliance requirements, and cost limits. The methods in this class include submit_execution_request, which allows the requesting application to send execution requests, and receive_execution_response, which enables the application to process the execution results returned by the system.

The Workload Management System (402) class is responsible for handling execution requests, coordinating with various components, and ensuring that microservices are executed in the most optimal manner. This class maintains attributes such as system_id and active_requests, which track the system's identification and the list of currently active execution requests. The workload management system provides several methods to facilitate execution management. The process_execution_request method receives execution requests and initiates processing. The query_microservices_catalog method interacts with the microservices catalog to retrieve metadata about requested microservices. The invoke_provider_selection_engine method determines the optimal cloud service provider based on performance, cost, and compliance factors. Additional methods include format_api_request, which prepares the execution request for transmission, transmit_request, which sends the request to the selected cloud service provider, monitor_execution, which continuously tracks execution performance, trigger_failover, which initiates an execution reroute if a failure is detected, and return_execution_response, which transmits the execution results back to the requesting application.

The Microservices Catalog (404) class stores and organizes metadata related to all available microservices. The attributes include catalog_id and available_microservices, where available_microservices maintains a dictionary of microservices and their associated cloud providers. The methods include retrieve_microservice_metadata, which fetches metadata about a requested microservice, and list_available_microservices, which allows system components to access a list of all registered microservices.

The Cloud Provider Selection Engine (406) class is responsible for identifying the best cloud provider for executing microservices based on various selection criteria. The class maintains attributes such as provider_list and weighted_cost_function, where provider_list contains a list of available cloud providers, and weighted_cost_function stores the selection logic that evaluates cloud providers based on real-time data. The methods include evaluate_providers, which assesses all available providers against execution constraints, fetch_historical_performance_data, which retrieves past execution performance data for a provider, apply_weighted_cost_function, which calculates the most cost-effective and efficient provider selection, and exclude_non_compliant_providers, which removes cloud providers that fail security, compliance, or stability checks.

The Historical Performance Database (408) class stores execution data for all cloud service providers, enabling the system to make data-driven provider selection decisions. The attributes include provider_execution_data, which maintains execution metrics such as execution times, error rates, response latencies, and cost efficiency. The methods include retrieve_provider_performance, which fetches historical execution data for a given provider, and store_execution_metrics, which logs new execution performance data for future analysis.

The Machine Learning Model (410) class provides predictive analytics to improve cloud provider selection and optimize workload execution over time. The attributes include model_weights, which store the trained weights used for decision-making, and execution_trends, which maintain historical patterns in execution performance. The methods include train_model, which updates the model using newly collected execution data, predict_best_provider, which determines the best cloud provider for an execution request based on historical trends, and update_weighted_cost_function, which refines the selection criteria in the cloud provider selection engine.

The API Abstraction Layer (412) class ensures that execution requests are formatted correctly for different cloud providers. The attributes include supported_api_formats, which track the various API formats supported by different cloud providers. The methods include translate_execution_request, which converts a generic execution request into a provider-specific format, encrypt_request, which secures execution requests before transmission, and send_request_to_provider, which transmits the formatted and encrypted request to the selected cloud service provider.

The Cloud Service Provider (414) class represents any cloud vendor that executes microservices upon receiving execution requests. The attributes include provider_id, which uniquely identifies the provider, and available_services, which lists the microservices that the provider supports. The methods include execute_microservice, which processes an incoming execution request, and return_execution_result, which sends the execution output back to the response processing module.

The Performance Monitoring Module (416) class continuously tracks execution progress and detects anomalies during microservice execution. The attributes include active_executions, which store real-time execution performance data. The methods include monitor_provider_execution, which tracks execution status for a given request, detect_anomalies, which identifies performance degradation or failures, and log_execution_performance, which records execution data for future reference.

The Fault Detection Module (418) class detects execution failures and performance degradation across cloud service providers. The attributes include failure_thresholds, which define acceptable performance limits for cloud providers. The methods include detect_execution_failures, which identifies service failures, and trigger_failover, which initiates failover procedures if a cloud provider is deemed unreliable.

The Response Processing Module (420) class ensures that execution results meet expected quality and completeness standards before being delivered to the requesting application. The attributes include validation_rules, which define criteria for validating execution responses. The methods include validate_execution_response, which checks execution results for errors, re-execute_microservice, which triggers re-execution on an alternate provider if errors are detected, and forward_response_to_application, which sends the validated execution output to the requesting application.

The Failover Module (422) class handles execution rerouting when a cloud provider fails or exhibits degraded performance. The attributes include failover_strategy, which defines how failover is managed. The methods include reroute_execution, which dynamically assigns execution to an alternate cloud provider, and synchronize_execution_state, which replicates execution state data across providers to enable seamless failover transitions.

The relationships between these classes define how different components interact to enable dynamic, intelligent, and optimized microservices execution. The requesting application communicates with the workload management system to submit execution requests and receive results. The workload management system coordinates execution by querying the microservices catalog, selecting an optimal provider using the cloud provider selection engine, formatting requests through the API abstraction layer, and transmitting execution requests to cloud service providers. Execution performance is continuously monitored by the performance monitoring module, and failures are detected by the fault detection module, which invokes the failover module if necessary. Execution results are processed by the response processing module before being returned to the requesting application. The historical performance database and machine learning model continuously refine the selection process, ensuring that workload distribution improves over time.

This class diagram provides a comprehensive structural representation of the microservices-based execution framework, ensuring that workloads are executed with optimal efficiency, cost-effectiveness, security, and reliability. The modular nature of the system allows for seamless integration of additional cloud providers and execution policies without modifying core application logic. By leveraging predictive analytics, real-time monitoring, and automated failover mechanisms, the system enables enterprises to maintain high availability and performance across a diverse multi-cloud environment.

Pseudocode exemplars for implementing various aspects of this disclosure are set forth below with explanations for reference.

### 1. System Initialization and Configuration

function initialize_system( ):
global microservices_catalog, cloud_providers, historical_performance_data, execution_log
global trained_ml_model, security_policies, workload_routing_policies
microservices_catalog={ } #Stores available microservices and their properties
cloud_providers={ } #Stores registered cloud providers and their characteristics
historical_performance_data={ } #Stores execution data for optimization
execution_log=[ ] #Keeps track of executed workloads
trained_ml_model=None #Machine learning model for workload optimization
security_policies={ } #Stores enterprise security and compliance requirements
workload_routing_policies={ } #Stores user-defined policies for routing workloads
load_microservices( )
load_cloud_providers( )
load_historical_data( )
train_machine_learning_model( )

### 2. Microservices Catalog Management

function load_microservices( )
for service in available_microservices:
   microservices_catalog[service.name]={
      “description”: service.description,
      “compatible_providers”: service.providers,
      “api_specification”: service.api_specification,
      “compliance_requirements”: service.compliance_requirements
   }

function register_microservice (service_name, description, providers, api_spec, compliance_reqs):
microservices_catalog[service_name]={
   “description”: description,
   “compatible_providers”: providers,
   “api_specification”: api_spec,
   “compliance_requirements”: compliance_reqs
}

function get_available_microservices( )
return list (microservices_catalog.keys( ))

### 3. Cloud Provider Registration and Metadata Storage

function load_cloud_providers( ):
for provider in available_cloud_providers:
   cloud_providers[provider.name]={
      “api_endpoints”: provider.api_endpoints,
      “pricing_model”: provider.pricing_model,
      “performance_metrics”: provider.performance_metrics,
      “security_compliance”: provider.security_compliance,
      “region_availability”: provider.region_availability
   }

function register_cloud_provider (provider_name, api_endpoints, pricing, performance_metrics, compliance, regions):
cloud_providers[provider_name]={
   “api_endpoints”: api_endpoints,
   “pricing_model”: pricing,
   “performance_metrics”: performance_metrics,
   “security_compliance”: compliance,
   “region_availability”: regions
}

function get_cloud_providers ( )
return list (cloud_providers.keys ( )

### 4. API Abstraction Layer for Cloud Vendor Communication

function call_microservice (service_name, input_data, user_defined_constraints={ }):
if service_name not in microservices_catalog:
   return “Error: Service not found”
optimal_provider=select_optimal_cloud_provider(service_name, user_defined_constraints)
if not optimal_provider:
   return “Error: No suitable provider found”
provider_api=cloud_providers[optimal_provider][“api_endpoints”]
formatted_request=format_api_request(service_name, input_data, provider_api)
response=execute_api_call(provider_api, formatted_request)
log_execution(service_name, optimal_provider, input_data, response)
return response

function format_api_request (service_name, input_data, provider_api):
return {
   “service”: service_name,
   “input”: input_data,
   “api_endpoint”: provider_api
}

function execute_api_call (provider_api, request):
return send_http_request (provider_api, request)

### 5. Intelligent Cloud Provider Selection

function select_optimal_cloud_provider (service_name, user_defined_constraints):
available_providers=microservices_catalog[service_name][“compatible_providers”]
best_provider=None
best_score=float(‘inf’)
for provider in available_providers:
   if not meets_compliance_requirements (service_name, provider):
      continue #Skip provider if it does not meet security requirements
   score=evaluate_provider (provider, service_name, user_defined_constraints)
   if score<best_score:
      best_score=score
      best_provider=provider
return best_provider

function evaluate_provider (provider, service_name, user_defined_constraints):
cost=cloud_providers[provider][“pricing_model”][service_name]
performance=cloud_providers[provider][“performance_metrics”][service_name]
security_compliance=cloud_providers[provider][“security_compliance”]
weight_cost=user_defined_constraints.get(“weight_cost”, 0.5)
weight_performance=user_defined_constraints.get(“weight_performance”, 0.4)
weight_security=user_defined_constraints.get(“weight_security”, 0.1)
weighted_score=(cost*weight_cost)+(1/performance*weight_performance)+(security_compliance*weight_security)
return weighted_score

### 6. Performance Monitoring and Metrics Storage

function monitor_performance(provider, service_name, execution_time, response_quality):
if provider not in historical_performance_data:
   historical_performance_data[provider]={ }
if service_name not in historical_performance_data[provider]:
   historical_performance_data[provider][service_name]=[ ]
historical_performance_data[provider][service_name].append({
   “execution_time”: execution_time,
   “response_quality”: response_quality,
   “timestamp”: get_current_time ( )
})

function compute_average_execution_time(provider, service_name):
data=historical_performance_data[provider][service_name]
return sum(entry [“execution_time”] for entry in data)/len (data)

### 7. Machine Learning-Based Optimization

function train_machine_learning_model ( )
training_data=[ ]
for provider in historical_performance_data:
   for service_name in historical_performance_data[provider]:
      for entry in historical_performance_data[provider][service_name]:
         training_data.append([
         provider,
         entry[“execution_time”],
         entry[“response_quality”],
         entry[“timestamp”]
         ])
trained_ml_model=train_ml_model(training_data)
return trained_ml_model

function predict_best_provider(service_name, input_data):
if trained_ml_model is None:
   train_machine_learning_model( )
predicted_provider=trained_ml_model.predict([service_name, input_data])
return predicted_provider

### 8. Dynamic Workload Routing and Optimization

function dynamic_workload_routing (service_name, input_data):
provider=predict_best_provider(service_name, input_data)
if provider is not available or provider is experiencing downtime:
   provider=select_optimal_cloud_provider(service_name)
response=call_microservice(service_name, input_data)
return response

### 9. Automated Failover Mechanism

function failover_mechanism (service_name, failed_provider):
alternative_provider=select_optimal_cloud_provider (service_name)
if alternative_provider:
   log_failover_event(failed_provider, alternative_provider)
   return alternative_provider
else:
   return “Error: No backup provider available”

function log_failover_event(failed_provider, alternative_provider):
execution_log.append({
   “failed_provider”: failed_provider,
   “new_provider”: alternative_provider,
   “timestamp”: get_current_time ( )
})

### 10. Security and Compliance Enforcement

function meets_compliance_requirements (service_name, provider):
required_compliance=microservices_catalog[service_name][“compliance_requirements”]
if cloud_providers[provider][“security_compliance”]<required_compliance:
   return False
return True

### 11. Monitoring and Reporting

function generate_performance_report ( )
report={ }
for provider in historical_performance_data:
   report[provider]={ }
   for service in historical_performance_data[provider]:
      report[provider][service]=compute_average_execution_time (provider, service)
return report

The above pseudocode provides a sample framework for managing microservice execution across multiple cloud service providers dynamically. The system is designed to optimize workload distribution by continuously evaluating cloud providers based on performance metrics, cost considerations, and compliance requirements. This implementation ensures that computational tasks are executed in the most efficient and cost-effective manner at any given moment. By leveraging real-time data and machine learning-driven predictions, the system intelligently selects cloud providers while maintaining seamless interoperability between applications and cloud environments. Every component within the pseudocode is structured to facilitate an automated, self-improving cloud execution strategy that eliminates manual intervention and maximizes efficiency.

The initialization function is a foundational aspect of the system, ensuring that all necessary components are loaded before execution begins. This function initializes key data structures, including the microservices catalog, the registry of cloud providers, historical performance data, execution logs, a trained machine learning model, security policies, and workload routing policies. The initialization process also invokes subfunctions responsible for loading predefined microservices, fetching metadata about available cloud providers, retrieving past execution data, and training the machine learning model if it has not yet been generated. By ensuring that the system starts with a fully prepared environment, the initialization function lays the groundwork for efficient, dynamic workload execution.

The microservices catalog serves as a structured repository for all available computational functions that can be executed across cloud providers. Each microservice entry consists of a name, description, a list of compatible cloud providers, API specifications, and compliance requirements. The system provides functions for loading microservices from a predefined list, dynamically registering new microservices, and retrieving a list of available services. By maintaining a structured catalog, the system ensures that workload execution remains consistent regardless of which cloud provider is ultimately selected. Each microservice entry also specifies its expected input and output formats, ensuring that applications calling these services can expect uniform behavior across different execution environments.

The cloud provider registry is another crucial component, as it maintains metadata on each cloud vendor, including API endpoints, pricing models, historical performance metrics, security compliance levels, and regional availability. This registry enables the system to evaluate and compare different cloud providers when determining where to execute a particular workload. When a cloud provider is registered, its metadata is stored in the system, allowing the provider to be dynamically considered for future workload execution. The registry is designed to support the addition of new cloud providers, ensuring that the system remains adaptable as new vendors enter the market or existing providers update their service offerings. By maintaining a comprehensive database of cloud provider characteristics, the system facilitates an informed and data-driven selection process.

The API abstraction layer is a critical aspect of the system, as it allows applications to interact with cloud services in a uniform manner. This layer acts as an intermediary, converting application requests into provider-specific API calls. When an application requests the execution of a microservice, the system first checks the microservices catalog to verify the requested function's availability. If the function exists, the system selects the optimal cloud provider and formats the request according to that provider's API specifications. The request is then sent to the cloud provider, and the system logs the execution details for future analysis. This abstraction layer ensures that applications remain decoupled from provider-specific details, allowing enterprises to transition between cloud providers without modifying application code.

The intelligent cloud provider selection mechanism is a core innovation of the system, designed to dynamically evaluate and select the most suitable cloud provider for a given workload. The selection process begins by retrieving a list of compatible cloud providers for the requested microservice. The system then evaluates each provider based on a weighted scoring function, which considers factors such as cost, performance, security compliance, and user-defined constraints. The provider with the lowest computed score is selected for execution. The scoring function allows enterprises to prioritize different factors based on their specific needs. For example, some enterprises may prioritize performance over cost, while others may emphasize security compliance. By providing a flexible scoring mechanism, the system ensures that provider selection aligns with enterprise priorities.

To maintain optimal decision-making, the system incorporates a performance monitoring module that continuously tracks execution metrics across cloud providers. This module records execution times, response quality, error rates, and other relevant performance indicators. The collected data is stored in a historical performance database, where it is periodically analyzed to compute provider rankings. By continuously updating provider rankings based on real-time data, the system adapts to changing cloud conditions and improves its workload distribution strategy over time. This adaptive approach ensures that the system remains responsive to fluctuations in cloud provider performance.

The system also features a machine learning-based optimization function that enhances workload distribution by leveraging predictive analytics. The machine learning model is trained on historical execution data, allowing it to identify patterns in cloud provider performance and cost variations. The model predicts the best provider for a given workload based on past execution trends. When a workload request is received, the system consults the trained model to determine the most suitable provider. This predictive approach reduces reliance on reactive decision-making and allows the system to anticipate and adjust to cloud service fluctuations proactively. The training process involves compiling execution logs from multiple providers and analyzing factors such as execution time, response quality, and cost. The resulting model improves the accuracy of provider selection and enhances the overall efficiency of workload execution.

The system includes a dynamic workload routing function that ensures workloads are always assigned to the most suitable cloud provider. When a workload request is received, the system first attempts to route the request to the provider predicted by the machine learning model. However, if that provider is unavailable or experiencing performance degradation, the system dynamically selects an alternate provider using its intelligent selection mechanism. This routing function allows the system to maintain high availability and resilience in the face of cloud provider disruptions. By continuously adjusting workload assignments based on real-time conditions, the system ensures that computational tasks are executed without delays or inefficiencies.

A robust failover mechanism is integrated into the system to handle cloud provider failures. If a provider becomes unresponsive or its performance drops below an acceptable threshold, the system automatically identifies an alternative provider and reroutes the workload. The failover process occurs seamlessly, ensuring uninterrupted execution. A failover event is logged, tracking the failed provider, the newly selected provider, and the timestamp of the transition. This failover mechanism enhances the system's reliability, allowing enterprises to maintain consistent operations even in the event of provider failures. Unlike traditional failover mechanisms that require manual intervention, this automated approach ensures that workload transitions occur without delays.

Security and compliance enforcement is another essential component of the system. Before assigning a workload to a provider, the system verifies whether the provider meets the necessary compliance standards. Each microservice has defined compliance requirements, and cloud providers are evaluated against these criteria. If a provider does not comply with the specified security policies, it is excluded from consideration. This ensures that workloads are executed in environments that align with enterprise security mandates and regulatory guidelines. Enterprises can configure security policies based on industry-specific requirements, ensuring that sensitive data is processed in accordance with regulatory standards.

Cost optimization is a key consideration in the system's design. The system periodically updates provider cost data by querying real-time pricing APIs. Since cloud service pricing fluctuates based on demand, the system ensures that workload assignments are always based on the most cost-effective execution environment. By continuously tracking pricing variations, the system minimizes cloud expenditures while maintaining high-performance execution. The cost optimization function allows enterprises to specify budget constraints, ensuring that workloads are allocated within predefined cost limits.

The system also includes a monitoring and reporting module that provides real-time insights into cloud service performance and usage trends. The system generates reports that summarize provider efficiency, historical execution trends, and cost savings achieved through workload optimizations. These reports allow enterprises to assess the effectiveness of their multi-cloud strategy and make data-driven decisions about resource allocation. The monitoring system also enables administrators to configure thresholds for performance and cost metrics, allowing for proactive adjustments to workload distribution.

The middleware architecture of the system ensures that it integrates seamlessly with existing enterprise applications. Since it operates as an intermediary between applications and cloud providers, organizations can adopt a multi-cloud strategy without making significant changes to their existing infrastructure. This middleware abstraction allows applications to execute workloads in a vendor-agnostic manner, simplifying deployment and management. By providing a streamlined interface, the system makes it easier for enterprises to transition to an optimized cloud computing model.

Overall, the sample pseudocode provides a comprehensive and highly detailed framework for dynamically managing microservice execution across multiple cloud providers. It incorporates intelligent provider selection, real-time performance monitoring, machine learning-driven optimization, automated failover mechanisms, security enforcement, cost tracking, and a middleware abstraction layer. These features collectively enable enterprises to maximize efficiency, minimize costs, and enhance computational performance in a multi-cloud environment. Through its sophisticated architecture, the system ensures that workloads are always executed in the optimal cloud environment based on real-time performance and pricing data, making it a transformative solution for enterprise cloud computing.

A skilled artisan, upon reviewing the disclosure, will appreciate that there are numerous alternatives, modifications, combinations, and customizations that can be made to the systems and methods described herein.

The systems and methods described herein can be adapted and customized in various ways to meet the specific needs of different industries, enterprises, and technical environments while remaining within the spirit and scope of the disclosure. One possible modification involves expanding the scope of supported microservices beyond stateless functions to include more complex, stateful workloads that require persistent storage or inter-service communication. In such implementations, additional mechanisms may be introduced to handle state synchronization across cloud providers, ensuring that workloads can transition seamlessly without loss of data integrity or execution continuity.

Another alternative involves incorporating additional decision-making factors into the intelligent cloud provider selection process. While the current implementation primarily considers performance, cost, and security compliance, additional factors such as environmental impact, energy consumption, carbon footprint, and data sovereignty requirements may also be integrated into the selection criteria. Enterprises with sustainability goals may prioritize cloud providers based on energy efficiency metrics, while organizations handling sensitive data may require workload execution in specific geographic regions to comply with local regulations. Custom weighting functions can be configured to optimize cloud selection based on industry-specific or business-driven priorities.

A further modification includes the extension of the system to hybrid cloud and edge computing environments. Instead of limiting execution to traditional public cloud service providers, the intelligent workload routing mechanism may be adapted to dynamically distribute workloads between on-premises data centers, private clouds, edge computing nodes, and public cloud services. This enhancement would allow enterprises to optimize computing resources across distributed infrastructures while reducing latency for time-sensitive applications. In such an implementation, the system may incorporate additional performance parameters, such as network proximity and bandwidth availability, to determine whether an execution should take place in a centralized cloud environment or closer to the end user at an edge location.

The system can also be enhanced by integrating additional machine learning techniques to improve predictive workload execution. Currently, historical performance data is leveraged to anticipate execution efficiency and cost fluctuations. However, deep learning models and reinforcement learning algorithms can be employed to enhance real-time decision-making, allowing the system to adapt dynamically based on evolving workload characteristics and cloud provider performance trends. These advanced models can refine workload allocation strategies by continuously learning from prior execution data, improving forecasting accuracy, and further minimizing cost and latency.

Alternative implementations may involve the incorporation of blockchain-based verification mechanisms to enhance security, auditability, and transparency in multi-cloud workload execution. A distributed ledger can be utilized to maintain immutable records of execution history, provider selection decisions, performance metrics, and cost transactions. This would ensure that workload execution remains verifiable and tamper-proof while enabling enterprises to maintain a transparent audit trail of all cloud-related operations. Smart contracts could be integrated into the system to enforce predefined execution policies automatically, ensuring compliance with security, regulatory, and service-level agreements.

The system's API abstraction layer can be further customized to support additional communication protocols beyond REST, such as gRPC, WebSockets, or GraphQL, depending on the needs of specific applications. This would provide greater flexibility in integrating microservices that operate under different architectural paradigms. Additionally, the system can be extended to support containerized workloads orchestrated through Kubernetes, enabling containerized applications to seamlessly migrate between cloud providers based on real-time performance and cost metrics. This approach would be particularly beneficial for enterprises leveraging microservices architectures in cloud-native application development.

Another alternative involves the customization of failover mechanisms to support user-defined redundancy strategies. While the current implementation automatically selects an alternate provider when a failure is detected, enterprises may require more granular control over failover priorities, such as specifying preferred backup providers or configuring failover sequences based on predefined risk tolerance levels. Custom failover rules can be implemented to ensure that workload transitions align with business continuity objectives while maintaining optimal execution performance.

The system can also be modified to incorporate additional real-time monitoring capabilities by leveraging serverless computing and event-driven architectures. Instead of relying solely on scheduled performance updates, event-driven triggers may be used to initiate workload reallocation when specific thresholds are met, such as a sudden spike in execution time, an unexpected cost increase, or a cloud provider outage. This would enable more responsive workload optimization by reducing the time lag between detecting inefficiencies and executing corrective actions.

Another possible customization is the implementation of a federated multi-cloud execution model, where workloads are not only dynamically allocated but also distributed across multiple providers simultaneously. In this scenario, portions of a single computational task may be split and executed in parallel across different cloud environments, leveraging provider-specific advantages for subcomponents of the workload. This would be particularly beneficial for high-performance computing (HPC) applications, artificial intelligence model training, and real-time analytics, where distributing computations across multiple resources can significantly accelerate processing times.

The system can also be enhanced by integrating additional security layers, such as confidential computing environments that enable encrypted processing of workloads on public cloud infrastructure. Secure enclaves and homomorphic encryption techniques may be used to ensure that sensitive computations can be performed securely across untrusted cloud environments without exposing raw data. This would expand the applicability of the system for industries handling highly confidential data, such as finance and government.

Another variation of the system involves the extension of the machine learning model to support adaptive workload scheduling based on long-term cloud provider performance trends. Instead of making provider selection decisions solely based on recent execution metrics, the system can analyze seasonality patterns, workload spikes, and historical anomalies to anticipate future performance fluctuations. This would enable proactive workload placement, ensuring that computational tasks are executed in environments that will remain stable and cost-effective over extended periods.

The system can also be adapted to integrate with DevOps pipelines and cloud orchestration tools, allowing organizations to automate workload routing as part of their continuous integration and deployment (CI/CD) processes. By embedding cloud provider selection and execution monitoring into software deployment workflows, enterprises can optimize application performance and cost throughout the software lifecycle. This would be particularly useful for organizations practicing infrastructure-as-code methodologies, where cloud resource allocation decisions are dynamically defined within automated deployment scripts.

A further extension involves enabling multi-tenancy support, where multiple organizations or departments within a company can use the same workload execution system while maintaining isolated configurations, security policies, and cost tracking mechanisms. This would allow enterprises to centrally manage cloud resource optimization for different teams while ensuring that each department retains control over its specific execution parameters. Multi-tenancy features could include role-based access controls, separate billing reports, and policy-driven execution constraints to align with organizational structures.

The system can also be enhanced by incorporating predictive cloud resource reservations to reduce long-term costs. Instead of making workload execution decisions solely based on real-time pricing, the system can analyze historical cost trends and proactively reserve cloud resources at discounted rates. Many cloud providers offer reserved instances or spot pricing models that allow enterprises to secure lower-cost computing resources in advance. By integrating these pricing models into workload allocation decisions, the system can further optimize cloud expenditures.

Another modification includes integrating support for edge AI and federated learning, allowing artificial intelligence models to be trained and executed across a distributed network of cloud and edge nodes. This would enable real-time AI inference at the edge while dynamically offloading complex computations to the cloud when additional processing power is required. By combining intelligent workload routing with AI-driven edge computing, the system could provide ultra-low-latency decision-making for applications such as autonomous vehicles, industrial automation, and smart cities.

The system can also be extended to provide proactive anomaly detection, where AI-based monitoring tools continuously analyze execution logs to identify unusual patterns in workload performance or cost anomalies. By flagging deviations from expected behavior, the system can trigger preemptive corrective actions, such as reassigning workloads to more reliable providers, adjusting execution parameters, or alerting administrators about potential risks. This would enhance the system's ability to maintain high availability and cost efficiency while minimizing the impact of unforeseen performance issues.

Ultimately, the invention provides a highly flexible and extensible framework for optimizing workload execution across multi-cloud environments. The numerous alternatives, modifications, combinations, and customizations outlined above illustrate the adaptability of the system to a wide range of use cases, industries, and computing environments. Each variation remains within the spirit and scope of the disclosure by adhering to the fundamental principles of intelligent workload allocation, real-time optimization, cloud vendor abstraction, and seamless execution across distributed computing environments. These potential enhancements demonstrate the robust and forward-looking nature of the invention, ensuring its continued relevance and applicability as cloud computing technologies evolve.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer-implemented method for dynamically selecting and executing microservices across multiple cloud service providers, the method comprising:
receiving, by a workload management system, a request for execution of a microservice, the request including input data and execution constraints;
retrieving, by a microservices catalog stored in a memory of the workload management system, metadata associated with the microservice, the metadata comprising a list of cloud service providers capable of executing the microservice, expected input and output formats, and compliance requirements;
identifying, by a cloud provider selection engine of the workload management system, a set of available cloud service providers from the list of cloud service providers in the microservices catalog that meet predefined execution constraints, wherein the predefined execution constraints include execution cost, computational performance, security compliance, and geographical availability;
retrieving, by a historical performance database of the workload management system, execution performance data for each cloud service provider in the set of available cloud service providers, the execution performance data comprising prior execution times, error rates, response latencies, and cost metrics;
evaluating, by an intelligent selection module of the workload management system, each cloud service provider in the set of available cloud service providers by applying a weighted cost function, the weighted cost function being computed based on the execution performance data, execution cost, service availability, and predefined user constraints;
selecting, by the intelligent selection module, an optimal cloud service provider for executing the microservice, wherein the optimal cloud service provider is determined based on a lowest computed value of the weighted cost function;
retrieving, by an application programming interface (API) abstraction layer of the workload management system, a cloud-specific API endpoint corresponding to the optimal cloud service provider, wherein the cloud-specific API endpoint is stored in a cloud provider registry of the workload management system;
formatting, by the API abstraction layer, the request for execution of the microservice into a provider-specific API request, wherein the provider-specific API request conforms to an API specification of the optimal cloud service provider;
transmitting, by the workload management system, the provider-specific API request to the optimal cloud service provider for execution;
monitoring, by a performance monitoring module of the workload management system, an execution status of the microservice on the optimal cloud service provider, wherein monitoring comprises collecting execution time, response quality, and resource utilization data;
storing, by the historical performance database, the execution time, response quality, and resource utilization data associated with the execution of the microservice for future workload optimization;
analyzing, by a machine learning model stored in a memory of the workload management system, the execution time, response quality, and resource utilization data to identify patterns in cloud service performance trends;
updating, by the workload management system, the weighted cost function based on predicted execution performance determined by the machine learning model;
determining, by a fault detection module of the workload management system, whether the optimal cloud service provider has failed or is experiencing performance degradation based on a threshold deviation from historical execution performance;
upon determining that the optimal cloud service provider has failed or is experiencing performance degradation, dynamically rerouting, by a failover module of the workload management system, execution of the microservice to an alternate cloud service provider selected based on an updated evaluation of the weighted cost function;
receiving, by the workload management system, a response from the optimal cloud service provider or the alternate cloud service provider, wherein the response comprises an output result generated by execution of the microservice; and
transmitting, by the workload management system, the output result to a requesting application.

2. The computer-implemented method of claim 1, wherein retrieving, by the historical performance database, execution performance data for each cloud service provider further comprises retrieving real-time cloud provider resource availability, including current CPU utilization, memory availability, network bandwidth, and active workload queues.

3. The computer-implemented method of claim 2, wherein evaluating, by the intelligent selection module, each cloud service provider in the set of available cloud service providers further comprises dynamically adjusting weight values in the weighted cost function based on historical workload trends, execution priority, and predefined service level agreement (SLA) constraints.

4. The computer-implemented method of claim 3, wherein selecting, by the intelligent selection module, the optimal cloud service provider further comprises excluding cloud service providers that have been flagged for security vulnerabilities or compliance violations within a predefined monitoring period.

5. The computer-implemented method of claim 4, wherein formatting, by the API abstraction layer, the request for execution of the microservice into a provider-specific API request further comprises applying protocol translation to adapt the request to one or more of REST, gRPC, WebSockets, GraphQL, or a provider-specific API format.

6. The computer-implemented method of claim 5, wherein transmitting, by the workload management system, the provider-specific API request to the optimal cloud service provider further comprises encrypting the provider-specific API request using a secure encryption algorithm prior to transmission and decrypting the response upon receipt.

7. The computer-implemented method of claim 6, wherein monitoring, by the performance monitoring module, the execution status of the microservice further comprises detecting execution anomalies by analyzing response latencies, error codes, and resource consumption spikes using anomaly detection models.

8. The computer-implemented method of claim 7, wherein analyzing, by the machine learning model, the execution time, response quality, and resource utilization data further comprises training the machine learning model using a federated learning approach that updates the model using execution data from multiple distributed cloud environments without centralizing sensitive execution data.

9. The computer-implemented method of claim 8, wherein determining, by the fault detection module, whether the optimal cloud service provider has failed further comprises detecting transient failures by performing multi-interval polling and differentiating between temporary delays and persistent service outages.

10. The computer-implemented method of claim 9, wherein dynamically rerouting, by the failover module, execution of the microservice to an alternate cloud service provider further comprises preemptively replicating execution state data across multiple cloud service providers to enable seamless stateful failover without re-executing the microservice from the initial request state.

11. A computer-implemented method for dynamically selecting, executing, and optimizing microservices across multiple cloud service providers, the method comprising:
receiving, by a workload management system, a request for execution of a microservice, the request including input data and execution constraints;
retrieving, by a microservices catalog stored in a memory of the workload management system, metadata associated with the microservice, the metadata comprising a list of cloud service providers capable of executing the microservice, expected input and output formats, and compliance requirements;
identifying, by a cloud provider selection engine of the workload management system, a set of available cloud service providers from the list of cloud service providers in the microservices catalog that meet predefined execution constraints, wherein the predefined execution constraints include execution cost, computational performance, security compliance, and geographical availability;
retrieving, by a historical performance database of the workload management system, execution performance data for each cloud service provider in the set of available cloud service providers, the execution performance data comprising prior execution times, error rates, response latencies, cost metrics, real-time cloud provider resource availability including current CPU utilization, memory availability, network bandwidth, and active workload queues;
evaluating, by an intelligent selection module of the workload management system, each cloud service provider in the set of available cloud service providers by applying a weighted cost function, the weighted cost function being computed based on the execution performance data, execution cost, service availability, and predefined user constraints, wherein the intelligent selection module dynamically adjusts weight values in the weighted cost function based on historical workload trends, execution priority, and predefined service level agreement constraints;
selecting, by the intelligent selection module, an optimal cloud service provider for executing the microservice, wherein the optimal cloud service provider is determined based on a lowest computed value of the weighted cost function, and wherein cloud service providers flagged for security vulnerabilities or compliance violations within a predefined monitoring period are excluded from selection;
retrieving, by an application programming interface (API) abstraction layer of the workload management system, a cloud-specific API endpoint corresponding to the optimal cloud service provider, wherein the cloud-specific API endpoint is stored in a cloud provider registry of the workload management system;
formatting, by the API abstraction layer, the request for execution of the microservice into a provider-specific API request, wherein the provider-specific API request conforms to an API specification of the optimal cloud service provider, and wherein the API abstraction layer applies protocol translation to adapt the request to one or more of REST, gRPC, WebSockets, GraphQL, or a provider-specific API format;
encrypting, by a security module of the workload management system, the provider-specific API request using a secure encryption algorithm prior to transmission;
transmitting, by the workload management system, the encrypted provider-specific API request to the optimal cloud service provider for execution;
monitoring, by a performance monitoring module of the workload management system, an execution status of the microservice on the optimal cloud service provider, wherein monitoring comprises collecting execution time, response quality, resource utilization data, and detecting execution anomalies by analyzing response latencies, error codes, and resource consumption spikes using anomaly detection models;
storing, by the historical performance database, the execution time, response quality, and resource utilization data associated with the execution of the microservice for future workload optimization;
analyzing, by a machine learning model stored in a memory of the workload management system, the execution time, response quality, and resource utilization data to identify patterns in cloud service performance trends, wherein the machine learning model is trained using a federated learning approach that updates the model using execution data from multiple distributed cloud environments without centralizing sensitive execution data;
updating, by the workload management system, the weighted cost function based on predicted execution performance determined by the machine learning model;
determining, by a fault detection module of the workload management system, whether the optimal cloud service provider has failed or is experiencing performance degradation based on a threshold deviation from historical execution performance, wherein the fault detection module detects transient failures by performing multi-interval polling and differentiating between temporary delays and persistent service outages;
upon determining that the optimal cloud service provider has failed or is experiencing performance degradation, dynamically rerouting, by a failover module of the workload management system, execution of the microservice to an alternate cloud service provider selected based on an updated evaluation of the weighted cost function;
preemptively replicating, by the failover module, execution state data across multiple cloud service providers to enable seamless stateful failover without re-executing the microservice from the initial request state;
receiving, by the workload management system, a response from the optimal cloud service provider or the alternate cloud service provider, wherein the response comprises an output result generated by execution of the microservice; and
transmitting, by the workload management system, the output result to a requesting application.

12. A system for dynamically selecting, executing, and optimizing microservices across multiple cloud service providers, the system comprising:
a workload management system configured to receive a request for execution of a microservice, the request including input data and execution constraints;
a microservices catalog stored in a memory of the workload management system, the microservices catalog configured to store metadata associated with the microservice, the metadata comprising a list of cloud service providers capable of executing the microservice, expected input and output formats, and compliance requirements;
a cloud provider selection engine communicatively coupled to the workload management system, the cloud provider selection engine configured to identify a set of available cloud service providers from the list of cloud service providers in the microservices catalog that meet predefined execution constraints, wherein the predefined execution constraints include execution cost, computational performance, security compliance, and geographical availability;
a historical performance database communicatively coupled to the workload management system, the historical performance database configured to retrieve execution performance data for each cloud service provider in the set of available cloud service providers, the execution performance data comprising prior execution times, error rates, response latencies, cost metrics, real-time cloud provider resource availability including current CPU utilization, memory availability, network bandwidth, and active workload queues;
an intelligent selection module communicatively coupled to the workload management system, the intelligent selection module configured to evaluate each cloud service provider in the set of available cloud service providers by applying a weighted cost function, the weighted cost function being computed based on the execution performance data, execution cost, service availability, and predefined user constraints, wherein the intelligent selection module is further configured to dynamically adjust weight values in the weighted cost function based on historical workload trends, execution priority, and predefined service level agreement constraints;
a security compliance filter communicatively coupled to the workload management system, the security compliance filter configured to exclude from selection cloud service providers flagged for security vulnerabilities or compliance violations within a predefined monitoring period;
an application programming interface (API) abstraction layer communicatively coupled to the workload management system, the API abstraction layer configured to retrieve a cloud-specific API endpoint corresponding to the optimal cloud service provider, wherein the cloud-specific API endpoint is stored in a cloud provider registry of the workload management system;
a protocol translation module communicatively coupled to the API abstraction layer, the protocol translation module configured to format the request for execution of the microservice into a provider-specific API request, wherein the provider-specific API request conforms to an API specification of the optimal cloud service provider, and wherein the protocol translation module is further configured to adapt the request to one or more of REST, gRPC, WebSockets, GraphQL, or a provider-specific API format;
a security module communicatively coupled to the workload management system, the security module configured to encrypt the provider-specific API request using a secure encryption algorithm prior to transmission;
a transmission module communicatively coupled to the workload management system, the transmission module configured to transmit the encrypted provider-specific API request to the optimal cloud service provider for execution;
a performance monitoring module communicatively coupled to the workload management system, the performance monitoring module configured to monitor an execution status of the microservice on the optimal cloud service provider, wherein monitoring comprises collecting execution time, response quality, resource utilization data, and detecting execution anomalies by analyzing response latencies, error codes, and resource consumption spikes using anomaly detection models;
a machine learning model stored in a memory of the workload management system, the machine learning model configured to analyze the execution time, response quality, and resource utilization data to identify patterns in cloud service performance trends, wherein the machine learning model is trained using a federated learning approach that updates the model using execution data from multiple distributed cloud environments without centralizing sensitive execution data;
a cost function update module communicatively coupled to the workload management system, the cost function update module configured to update the weighted cost function based on predicted execution performance determined by the machine learning model;
a fault detection module communicatively coupled to the workload management system, the fault detection module configured to determine whether the optimal cloud service provider has failed or is experiencing performance degradation based on a threshold deviation from historical execution performance, wherein the fault detection module is further configured to detect transient failures by performing multi-interval polling and differentiating between temporary delays and persistent service outages;
a failover module communicatively coupled to the workload management system, the failover module configured to, upon determining that the optimal cloud service provider has failed or is experiencing performance degradation, dynamically reroute execution of the microservice to an alternate cloud service provider selected based on an updated evaluation of the weighted cost function;
a state replication module communicatively coupled to the workload management system, the state replication module configured to preemptively replicate execution state data across multiple cloud service providers to enable seamless stateful failover without re-executing the microservice from the initial request state;
a response processing module communicatively coupled to the workload management system, the response processing module configured to receive a response from the optimal cloud service provider or the alternate cloud service provider, wherein the response comprises an output result generated by execution of the microservice; and
a response transmission module communicatively coupled to the workload management system, the response transmission module configured to transmit the output result to a requesting application.

13. The system of claim 12, wherein the historical performance database is further configured to store execution performance data categorized by time of day, day of the week, and seasonal trends to enable time-based optimization of cloud service provider selection.

14. The system of claim 13, wherein the intelligent selection module is further configured to assign priority weights to cloud service providers based on historical execution reliability, wherein higher priority is given to cloud service providers with lower failure rates and consistent performance over time.

15. The system of claim 14, wherein the API abstraction layer is further configured to cache provider-specific API request formats for cloud service providers that have been previously selected to reduce latency in generating subsequent execution requests.

16. The system of claim 15, wherein the machine learning model is further configured to detect long-term degradation trends in cloud service provider performance by analyzing historical execution data spanning multiple months and updating cloud provider rankings accordingly.

17. The system of claim 16, wherein the fault detection module is further configured to issue preemptive workload migration alerts when a cloud service provider exhibits execution performance degradation exceeding a predefined threshold over a rolling time window.

18. The system of claim 17, wherein the failover module is further configured to execute staged failover transitions, wherein workloads are gradually migrated from a failing cloud service provider to an alternate cloud service provider to prevent sudden load spikes and ensure a smooth transition.

19. The system of claim 18, wherein the state replication module is further configured to synchronize execution state data using distributed ledger technology to ensure consistency and integrity of workload execution data across multiple cloud service providers.

20. The system of claim 19, wherein the response processing module is further configured to apply response validation rules to detect incomplete or erroneous execution results from cloud service providers and initiate re-execution of the microservice if necessary.
